(19) United States
(12) Patent Application Publication
(10) Pub. No.: US 2025/0246678 A1
(43) Pub. Date: Jul. 31, 2025

(54) COMPOSITE SOLID ELECTROLYTE, METHOD OF PREPARING COMPOSITE SOLID ELECTROLYTE, AND LITHIUM BATTERY INCLUDING COMPOSITE SOLID ELECTROLYTE

(71) Applicant: Samsung Electronics Co., Ltd., Suwon-si (KR)

(72) Inventors: Youngjoon Bae, Suwon-si (KR); Giyun Kwon, Suwon-si (KR); Hyeokjo Gwon, Suwon-si (KR); Taeyoung Kim, Suwon-si (KR); Jeongkuk Shon, Suwon-si (KR); Heungchan Lee, Suwon-si (KR)

(21) Appl. No.: 19/028,845

(22) Filed: Jan. 17, 2025

(30) Foreign Application Priority Data
Jan. 31, 2024 (KR) 10-2024-0015189

(51) Int. Cl. H01M 10/0562; H01M 10/052

(52) U.S. Cl. CPC H01M 10/0562; H01M 10/052; H01M 2300/0077; H01M 2300/008; H01M 2300/0088

(57) ABSTRACT

A composite solid electrolyte, a method of preparing the same, and a lithium battery including the same, wherein the composite solid electrolyte includes a first solid electrolyte and a second solid electrolyte. The first solid electrolyte includes a cubic garnet phase and a pyrochlore phase and the second solid electrolyte includes lithium haloboracite. A volume of the first solid electrolyte is greater than a volume of the second solid electrolyte based on a total volume of the composite solid electrolyte and the lithium haloboracite includes chlorine, bromine, iodine, or a combination thereof.

### CROSS-REFERENCES TO RELATED APPLICATION

This application is based on and claims priority to Korean Patent Application No. 10-2024-0015189, filed on Jan. 31, 2024, in the Korean Intellectual Property Office, and all benefits accruing therefrom under 35 U.S.C. § 119, the content of which is herein incorporated by reference in its entirety.

### BACKGROUND

### 1. Field

The disclosure relates to a composite solid electrolyte, a method of preparing the composite solid electrolyte, and a lithium battery including the composite solid electrolyte.

### 2. Description of the Related Art

Lithium batteries typically provide improved specific energy (watt-hour per kilogram, Wh/kg) and/or energy density (watt-hour per cubic centimeter, Wh/cc).

A lithium battery may include a solid electrolyte for improved stability. Use of a solid electrolyte can reduce the risk of fire and simplify the manufacturing process.

Among solid electrolytes, a garnet-type oxide solid electrolyte is a typical core material of an oxide all-solid secondary battery. Garnet-type oxide solid electrolyte generally have high ionic conductivity, and excellent chemical stability with lithium. Although the garnet-type oxide solid electrolyte has a high theoretical lithium-ion conductivity, it is an oxide material and usually requires a densification process through sintering at a high temperature of about 1,200° C. to provide excellent lithium-ion conductivity. To address the aforementioned issues, methods of lowering a sintering temperature by introducing various sintering agents have been used. However, the use of sintering agents may limit the extent the sintering temperature can be improved, and using a garnet-type oxide solid electrolyte together with sintering agents may lead to issues of additional interface formation and side reactions.

A need remains for a material which can be sintered at a low temperature to provide a solid electrolyte with a high conductivity.

### SUMMARY

Provided is a composite solid electrolyte which can be sintered at low temperature and has high conductivity.

Provided is a lithium battery including the composite solid electrolyte.

Provided is a method of preparing the composite solid electrolyte.

Additional aspects will be set forth in part in the description which follows and, in part, will be apparent from the description, or may be learned by practice of the presented embodiments of the present disclosure.

According to an aspect of the disclosure, a composite solid electrolyte includes a first solid electrolyte and a second solid electrolyte. The first solid electrolyte includes a cubic garnet phase and a pyrochlore phase and the second solid electrolyte includes lithium haloboracite. A volume of the first solid electrolyte is greater than a volume of the second solid electrolyte based on a total volume of the composite solid electrolyte, and the lithium haloboracite includes chlorine (Cl), bromine (Br), iodine (I), or a combination thereof.

The lithium haloboracite may include a crystalline phase. In addition, a crystallization temperature T1 of the first solid electrolyte may be less than a crystallization temperature T2 of the second solid electrolyte.

The crystallization temperature of the first solid electrolyte may be about 300° C. to about 450° C., and the crystallization temperature of the second solid electrolyte may be about 450° C. to about 550° C.

The composite solid electrolyte may be a heat-treated product of a composite solid electrolyte-forming composition, that is, a heat-treated product of a mixture of a first solid electrolyte precursor and a second solid electrolyte precursor. A heat-treatment temperature T of the composite solid electrolyte-forming composition may be 600° C. or less, or 550° C. or less. A crystallization temperature T1 of the first solid electrolyte, a heat-treatment temperature T of the composite solid electrolyte-forming composition, and a crystallization temperature T2 of the second solid electrolyte may satisfy Relation 1:

T1<T2<T. Relation 1

The composite solid electrolyte may have a structure in which a second solid electrolyte is dispersed in pores of a matrix of a first solid electrolyte.

The average crystallite size of a crystalline phase of the first solid electrolyte may be about 50 nanometers (nm) to about 50 micrometers (μm). In addition, the composite solid electrolyte may have an ionic conductivity of about 1×10⁻⁶ siemens per centimeter (S/cm) to about 1×10⁻³ S/cm, and the composite solid electrolyte may have a relative density of about 80% to about 99.5% based on a theoretical density of the composite solid electrolyte.

The composite solid electrolyte may have a thickness of about 1 μm to about 500 μm.

In the composite solid electrolyte, the amount of the first solid electrolyte may be greater than 50 volume percent (vol %) and 99 vol % or less with respect to the total volume of the composite solid electrolyte (the total volume of the first solid electrolyte and the second solid electrolyte).

The composite solid electrolyte may have a porosity of about 0.5% to about 20%.

The first solid electrolyte may include a compound represented by Formula 1.

(LiₓAₐ)(La_{y}B′_{b})(Zr_{z}C′_{c})O₁₂ Formula 1

In Formula 1, A may be a monovalent cation, a divalent cation, a trivalent cation, or a combination thereof, B′ may be a monovalent cation, a divalent cation, a trivalent cation, or a combination thereof, C′ may be a monovalent cation, a divalent cation, a trivalent cation, a tetravalent cation, a pentavalent cation, a hexavalent cation, or a combination thereof, and 5≤x≤7, 0≤a≤2, 2≤y≤3, 0≤b≤1, 0<z≤2, and 0≤c≤2.

In an embodiment in Formula 1, 6≤x+a≤8, 2≤y+b≤4, and 1≤z+c≤3.

In an embodiment in Formula 1, x>a and 0<a≤1.

In an embodiment in Formula 1, z>c, 1.5≤z≤2.0, and 0.01≤c≤0.5.

The solid electrolyte represented by Formula 1 may include a compound represented by Formula 2, a compound represented by Formula 3, or a combination thereof.

Liₓ(La_{y}B′_{b})(Zr_{z}C′_{c})O₁₂ Formula 2

In Formula 2, B′ may be calcium (Ca), strontium (Sr), cesium (Ce), barium (Ba), or a combination thereof, C′ may be aluminum (Al), tungsten (W), niobium (Nb), tantalum (Ta), or a combination thereof, 5≤x≤7, 2≤y≤3, 0<z≤2, 0<b≤1, and 0.01≤c≤2.

In an embodiment in Formula 2, 2≤y+b≤4, and 1≤z+c≤3.

In an embodiment in Formula 2, z>c, 1.5≤z≤2.0, and 0.01≤c≤0.5.

In an embodiment in Formula 2, z>c, 1.5≤z≤2.0, and 0.01≤c≤0.5, and 2≤y+b≤4, and 1≤z+c≤3.

(LiₓAₐ)(La_{y})(Zr_{z})O₁₂ Formula 3

In Formula 3, A may be gallium (Ga), aluminum (Al), or a combination thereof, and 5≤x≤7, 0≤a≤2, 2≤y≤3, and 0<z≤2.

In Formula 3, x>a.

The compound represented by Formula 1 may contain a compound represented by Formula 4.

Liₓ(La_{y}B′_{b})(Zr_{z}C′_{c})O₁₂ Formula 4

In Formula 4, B′ may be calcium (Ca), strontium (Sr), cesium (Ce), barium (Ba), or a combination thereof, C′ may be aluminum (Al), tungsten (W), niobium (Nb), tantalum (Ta), or a combination thereof, and 5≤x≤7, 2≤y≤3, 0≤b≤1, 0<z≤2, and 0.01≤c≤2.

In an embodiment in Formula 4, 2≤y+b≤4 and 1≤z+c≤3.

In an embodiment in Formula 4, z>c, 1.5≤z≤2.0, and 0.01≤c≤0.5.

The second solid electrolyte may be, for example, a compound represented by Formula 5.

Liₐ(BₓM_{y}N_{z})O_{b}X_{c} Formula 5

In Formula 5, 4≤a≤7, 12≤b≤13, 0<c≤1, 0<x≤7, 0≤y≤3, 0≤z≤1, and 6≤x+y+z≤7,
M and N each independently may be Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, W, or a combination thereof and
X may be Cl, Br, I, or a combination thereof.

The second solid electrolyte may be, for example, a compound represented by Formula 5-1.

Liₐ(BₓM_{y}N_{z})O_{b}Cl_{c} Formula 5-1

In Formula 5-1, 4≤a≤7, 12≤b≤13, 0<c≤1, 0<x≤7, 0<y≤3, 0≤z≤1, and 6≤x+y+z≤7, and M and N each independently may be Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta W, or a combination thereof.

When the composite solid electrolyte is analyzed by X-ray diffraction (XRD) using Cu Kα radiation, peaks associated with a pyrochlore phase may appear at a diffraction angle of about 27.5°2θ to about 29°2θ, about 32°2θ to about 33.5°2θ, about 46.5°2θ to about 48°2θ, and about 55°2θ to about 56.5°2θ.

According to another aspect of the disclosure, a lithium battery includes a cathode; an anode; and an electrolyte layer disposed between the cathode and the anode. The cathode, the anode, the electrolyte layer, or a combination thereof includes the composite solid electrolyte. The lithium battery may be a lithium-ion battery, an all-solid secondary battery, or a lithium-air battery, and the all-solid secondary battery may be, for example, a multilayer ceramic (MLC) battery.

The cathode may include the composite solid electrolyte.

According to another aspect of the disclosure, a method of preparing a composite solid electrolyte includes:
mixing a first solid electrolyte precursor having an amorphous phase with a second solid electrolyte precursor having a glass phase to prepare a composite solid electrolyte-forming composition; and
heat-treating the composite solid electrolyte-forming composition to prepare the composite solid electrolyte.

The composite solid electrolyte may include a first solid electrolyte including a cubic-garnet phase and a pyrochlore phase and a second solid electrolyte including lithium haloboracite, wherein a volume of the first solid electrolyte is greater than a volume of a second solid electrolyte based on a total volume of the composite solid electrolyte.

The lithium haloboracite may include chlorine (Cl), bromine (Br), iodine (I), or a combination thereof.

The lithium haloboracite may include a crystalline phase.

The heat treating of the composite solid electrolyte-forming composition may be performed at a temperature greater than a crystallization temperature of the first solid electrolyte precursor and a crystallization temperature of the second solid electrolyte precursor. The heat treating of the composite solid electrolyte-forming composition may be performed at 600° C. or less.

In addition, the composite solid electrolyte may be a heat-treated product of the composite solid electrolyte-forming composition, a heat treatment temperature T of the composite solid electrolyte-forming composition may be 600° C. or less, a heat treatment temperature T of the composite solid electrolyte may be 600° C. or less, and a crystallization temperature T1 of the first solid electrolyte, a heat treatment temperature T of the composite solid electrolyte-forming composition, and a crystallization temperature T2 of the second solid electrolyte may satisfy Relation 1.

T1<T2<T Relation 1

The second solid electrolyte may be a compound represented by Formula 5:

Liₐ(B′ₓM_{y}N_{z})O_{b}X_{c} Formula 5:

In Formula 5, 4≤a≤7, 12≤b≤13, 0<c≤1, 0<x≤7, 0≤y≤3, 0≤y≤1, and 6≤x+y+z≤7, M and N may be each independently Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, W, or a combination thereof, and X may be Cl, Br, I, or a combination thereof.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A to 1C are diagrams illustrating an embodiment of a process of forming a composite solid electrolyte;

FIG. 1D is a schematic diagram illustrating an embodiment of a structure of a composite solid electrolyte;

FIG. 2A is a graph illustrating intensity (arbitrary units, a.u.) versus diffraction angle (degrees 28) of an X-ray diffraction (XRD) spectrum of an amorphous first solid composite precursor prepared in Preparation Example 1;

FIG. 2B is a graph illustrating heat flow (a.u.) versus temperature (° C.) of the of differential scanning calorimetry (DSC) spectra of an amorphous first solid electrolyte precursor and a glass-phase second solid electrolyte precursor used in Example 1;

FIG. 2C is a graph illustrating intensity (arbitrary units, a.u.) versus diffraction angle (degrees 2θ) of XRD spectra of composite solid electrolytes of Examples 1 to 3, LLZTO, and La_{2.4}Zr_{1.2}Ta_{0.4}O₇;

FIG. 3 is a schematic cross-sectional diagram of a structure of an embodiment of an all-solid secondary battery;

FIG. 4 is a schematic cross-sectional diagram of an embodiment of a structure of an all-solid secondary battery;

FIG. 5 is a schematic cross-sectional diagram of an embodiment of a structure of an all-solid secondary battery;

FIG. 6 is a schematic cross-sectional diagram of an embodiment of a structure of a multilayer ceramic battery;

FIG. 7 is a schematic cross-sectional diagram of an embodiment of a structure of a multilayer ceramic battery according to another embodiment; and

FIG. 8 is a schematic cross-sectional diagram of an embodiment of a structure of a multilayer ceramic battery according to another embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The present inventive concept, which will be more fully described hereinafter, may have various variations and various embodiments, and specific embodiments will be illustrated in the accompanying drawings and described in greater detail. However, the present inventive concept should not be construed as being limited to specific embodiments set forth herein. Rather, these embodiments are to be understood as encompassing all variations, equivalents, or alternatives included in the scope of the present inventive concept.

Unless explicitly stated otherwise in the present specification, when an element, such as a layer, a film, an area, and a plate, is referred to as being “on” or “over” another element, it can be directly on the other element or intervening elements may also be present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Unless explicitly stated otherwise in the present specification, any terms expressed in the singular form may also include the plural form. Further, unless explicitly stated otherwise, “including A or B” may mean “including A, including B, or including A and B”.

The term “a combination thereof” as used herein may mean a mixture, a laminate, a composite, a copolymer, an alloy, a reaction product, or the like, of referents.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The terminology used hereinbelow is used for the purpose of describing particular embodiments only, and is not intended to limit the present inventive concept. As used herein, the singular forms are intended to include the plural forms as well, unless the context clearly indicates otherwise. As used herein, the terms “comprises” and/or “comprising,” or “includes” and/or “including” specify the presence of stated features, regions, integers, steps, operations, elements, components, ingredients, materials, or combinations thereof, but do not preclude the presence or addition of one or more other features, regions, integers, steps, operations, elements, components, ingredients, materials, or combinations thereof. As used herein, “/” may be interpreted as “and”, or as “or” depending on the context.

In the drawings, the thicknesses of layers and regions may be exaggerated for clarity of description. Like reference numerals denote like elements throughout the specification. Throughout the specification, when a component, such as a layer, a film, a region, or a plate, is described as being “above” or “on” another component, the component may be directly above the other component, or there may be yet another component therebetween. It will be understood that although the terms “first,” “second,” etc. may be used herein to describe various elements, these elements should not be limited by these terms. These terms are only used to distinguish one element from another element.

The term “metal” as used herein refers to both metals and metalloids such as silicon and germanium, in an elemental or ionic state.

The term “alloy” as used herein refers to a mixture of two or more metals.

As used herein, the term “cathode active material” refers to a cathode material capable of undergoing lithiation and delithiation, and the term “anode active material” refers to an anode material capable of undergoing lithiation and delithiation.

As used herein, the terms “lithiation” and “to lithiate” refer to a process of adding lithium to a cathode active material or an anode active material, and the terms “delithiation” and “to delithiate” refer to a process of removing lithium from a cathode active material or an anode active material.

As used herein, the terms “charging” and “to charge” refer to a process of providing electrochemical energy to a battery, and the terms “discharging” and “to discharge” refer to a process of removing electrochemical energy from a battery.

As used herein, the terms “positive electrode” and “cathode” refer to an electrode at which electrochemical reduction and lithiation take place during a discharging process, and the terms “negative electrode” and “anode” refer to an electrode at which electrochemical oxidation and delithiation take place during a discharging process.

The term “particle diameter” of particles, as used herein, refers to an average diameter if the particles are spherical, and refers to an average major axis length if the particles are non-spherical. The term “particle diameter” of particles, as used herein, refers to, for example, an average particle diameter. The average particle diameter, unless otherwise expressly indicated, refers to a median particle diameter (D50). Median particle diameter (D50) refers to the size of particles corresponding to a cumulative value of 50% as counted from the smallest particle size on a particle size distribution curve in which particles in the sample are accumulated from the smallest particle size to the largest particle size. The cumulative value may be, for example, a cumulative volume. The average particle size (D50) may be measured by methods widely known to those skilled in the art. For example, the average particle size (D50) may be measured by a particle size analyzer, or may be measured by using a transmission electron microscopy image, or a scanning electron microscopy image. Alternatively, such measurements may be taken by a measurement device using a dynamic light-scattering technique, and the number of particles within a given particle size range may be counted through data analyses, and an average particle diameter (D50) value may be calculated therefrom. Alternatively, the average particle diameter (D50) may be measured using a laser diffraction method. If a measurement is made by a laser diffraction method, for example, particles to be measured may be dispersed in a dispersion medium and subjected to ultrasonic radiation at about 28 kilohertz (kHz) and a power output of 60 Watts, and the average particle diameter (D50) may be calculated based on 50% in the particle size distribution according to the measurement device.

The size of particles, if measured using a scanning electron microscope, may be determined as the average value of particle diameters of 30 or more randomly selected particles of 1 micrometer (μm) or greater, excluding fine particles.

The average particle diameter of the cathode active material may be measured using a laser diffraction method. More specifically, the cathode active material may be dispersed in a solution and introduced into a commercial laser diffraction particle size measurement device (e.g., Microtrac MT 3000) to undergo ultrasonic radiation at about 28 kHz and a power output of 60 Watts, and the average particle diameter (D50) may be calculated based on 50% in the particle size distribution according to the measurement device.

The term “D10” as used herein may refer to an average diameter of particles corresponding to a cumulative 10 vol % in a particle size distribution, and the term “D90” as used herein may refer to an average diameter of particles corresponding to a cumulative 90 vol % in a particle size distribution.

In the present disclosure, thickness represents an average thickness.

Garnet is commonly understood to be a silicate that can be referred to using the formula X₃Y₂(SiO₄)₃, wherein X is a divalent cation, and Y is a trivalent cation. As used herein, the term “garnet” or “garnet-type” means that the compound is isostructural with garnet, e.g., Mg₃Al₂(SiO₄)₃. As used herein, the term “cubic garnet” means that the compound has cubic symmetry and is isostructural with garnet. As used herein, the term “isostructural” refers to crystal structures of chemical compounds. The crystal structures are the same, but the cell dimensions and/or the chemical composition may not be the same.

Pyrochlore is commonly understood to be a niobium oxide that can be referred to using the formula (NaₐCaₐ₋₁)₂Nb₂O₆(OH_{b}F_{b-1}), wherein 0≤a≤1 and 0≤b≤1. As used herein, the term “pyrochlore phase” means that the compound is isostructural with pyrochlore.

Hereinbelow, a composite solid electrolyte according to an embodiment, a method of preparing the composite solid electrolyte, and a lithium battery including the composite solid electrolyte will be described in greater detail.

When preparing an all-solid battery using a NASICON solid electrolyte, the sintering temperature can be as high as about 700° C., and the window for the reduction potential can be low, restricting electrode active materials and lowering the cell energy density. A method using a glass solid electrolyte instead of a NASICON solid electrolyte is disclosed herein. Although such glass electrolytes may be used as various electrode active materials, due to their low conductivity, improved performance of the resultant electrode active materials is of interest.

A garnet-type oxide solid electrolyte has excellent conductivity at room temperature. But due to characteristics of the rigid oxide material, a garnet-type oxide solid electrolyte may require high-temperature sintering for connection between particles. However, such a high-temperature sintering process may lead to a secondary phase through side reactions with active materials, or may cause degradation in individual active materials and electrolyte materials. Accordingly, for the effective use of an oxide solid electrolyte, it is desirable for the heat-treatment temperature (i.e., the processing temperature) to be decreased to suppress or prevent side reactions with the active materials. However, a decreased heat-treatment temperature may be insufficient to provide connections between particles with the electrolyte, leading to a significant decrease in the ionic conductivity of a garnet-type oxide solid electrolyte. Therefore, maintaining high conductive characteristics of a garnet-type crystalline electrolyte by adding a material capable of forming interfaces at low temperature may be advantageous.

To address some of the aforementioned issues, provided is a composite solid electrolyte which can be sintered at low temperature compared to garnet-type oxide solid electrolytes, and has high conductivity. Such a composite solid electrolyte does not cause side reactions with electrode active materials and thus may allow improved use of various electrode active materials.

### Composite Solid Electrolyte

A composite solid electrolyte according to an embodiment may include a first solid electrolyte and a second solid electrolyte, the first solid electrolyte containing a cubic garnet phase and a pyrochlore phase, and the second solid electrolyte including lithium haloboracite, wherein a volume of the first solid electrolyte is greater than a volume of the second solid electrolyte, and the lithium haloboracite includes chlorine (Cl), bromine (Br), iodine (I), or a combination thereof. The lithium haloboracite may include a crystalline phase, and examples of the lithium haloboracite may include lithium chloroboracite, lithium bromoboracite, lithium iodoboracite, or a combination thereof.

The composite solid electrolyte may comprise a first solid electrolyte having a cubic garnet phase and a pyrochlore phase, and a second solid electrolyte having lithium haloboracite, obtained after sintering a first solid electrolyte precursor in an amorphous state and a second solid electrolyte precursor having a glass phase.

The sintering temperature of the first solid electrolyte precursor and the second solid electrolyte precursor having a glass phase for forming the composite solid electrolyte may be a temperature greater than a crystallization temperature of the first solid electrolyte and a crystallization temperature of the second solid electrolyte. If using the composite solid electrolyte, a lithium battery that can be sintered at a temperature of 600° C. or less, and has improved energy density may be prepared. By using such a solid electrolyte, a lithium battery having improved cycling performance may be provided.

The first solid electrolyte may have high conductivity, and the second solid electrolyte may have excellent deformability.

Because connections between particles are made as the first solid electrolyte precursor in an amorphous state undergoes a crystallization process, and interfacial resistance between particles decrease as the second solid electrolyte precursor having a glass phase is filled between the first solid electrolytes, or as the second solid electrolyte is crystallized through a subsequent heat treatment, a composite solid electrolyte having improved ionic conductivity and high relative density may be prepared.

The crystallization temperature of the first solid electrolyte may be less than the crystallization temperature of the second solid electrolyte, and a heat treatment temperature, e.g., sintering temperature, of the composite solid electrolyte-forming composition including a first solid electrolyte precursor having an amorphous phase and a second solid electrolyte precursor having a glass phase may be greater than the crystallization temperature of the first solid electrolyte and the crystallization temperature of the second solid electrolyte.

The heat treatment temperature, e.g., sintering temperature T, of a mixture of the first solid electrolyte precursor and the second solid electrolyte precursor for the preparation of the composite solid electrolyte may be 600° C. or less, or 500° C. or less. A crystallization temperature T1 of the first solid electrolyte, a heat treatment temperature, e.g., sintering temperature T of the composite solid electrolyte-forming composition, and a crystallization temperature T2 of the second solid electrolyte may satisfy Relation 1.

T1<T2<T Relation 1

The heat treatment temperature, e.g., sintering temperature T, of a mixture of the first solid electrolyte precursor and the second solid electrolyte precursor for the preparation of the composite solid electrolyte may be 600° C. or less or 550° C. or less, and may be, for example, about 350° C. to about 550° C., about 380° C. to about 550° C., about 400° C. to about 550° C., or about 450° C. to about 550° C. The heat treatment time of the mixture of the first solid electrolyte precursor and the second solid electrolyte precursor may vary depending on the heat treatment temperature, but may be, for example, about 10 minutes to about 2 hours. In addition, the crystallization temperature T1 of the first solid electrolyte may be about 300° C. to about 450° C., about 350° C. to about 430° C., or about 380° C. to about 420° C. The crystallization temperature T2 of the second solid electrolyte may be about 450° C. to about 550° C., more than 450° C. to 550° C. or less, more than 450° C. to 520° C. or less, or more than 450° C. to 500° C. or less.

If the crystallization temperature T1 of the first solid electrolyte, the sintering temperature T, and the crystallization temperature T2 of the second solid electrolyte are within the aforementioned ranges, a composite solid electrolyte having low-temperature sintering properties and improved ionic conductivity may be prepared.

In a composite solid electrolyte according to an embodiment, lithium haloboracite of the second solid electrolyte may have a crystalline phase, a glass phase, or both. For example, the lithium haloboracite of the second solid electrolyte may have a structure composed of 100 weight percent (wt %) of a crystalline phase. Alternatively, the lithium haloboracite of the second solid electrolyte may have a structure including a crystalline phase and a glass phase. Alternatively, the lithium haloboracite of the second solid electrolyte may have a structure containing 100 wt % of a glass phase.

The lithium haloboracite of the second solid electrolyte may have a glass-ceramic structure that comprises a ceramic phase (crystalline phase) as a main phase and a glass phase as a minor phase. In particular, the amount of the minor phase, e.g., the glass phase, may be 5 wt % or less, 1 wt % or less, or about 0.001 wt % to about 1 wt %, with respect to the total weight of the lithium haloboracite.

In the present disclosure, the term “glass” refers to an amorphous material exhibiting a glass transition behavior. In addition, the term “glass-ceramic” as used herein refers to a material in which an amorphous material is present with one or more crystalline materials, wherein two components of a glass phase (amorphous phase) and a ceramic phase (crystalline phase) can be observed.

Because the second solid electrolyte includes lithium haloboracite containing a crystalline phase and has a high ionic conductivity of 1×10⁻⁶ siemens per centimeter (S/cm) or greater, the composite solid electrolyte may have improved ionic conductivity.

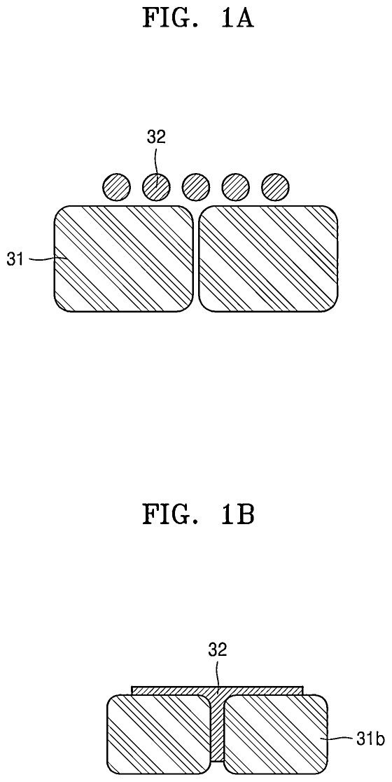

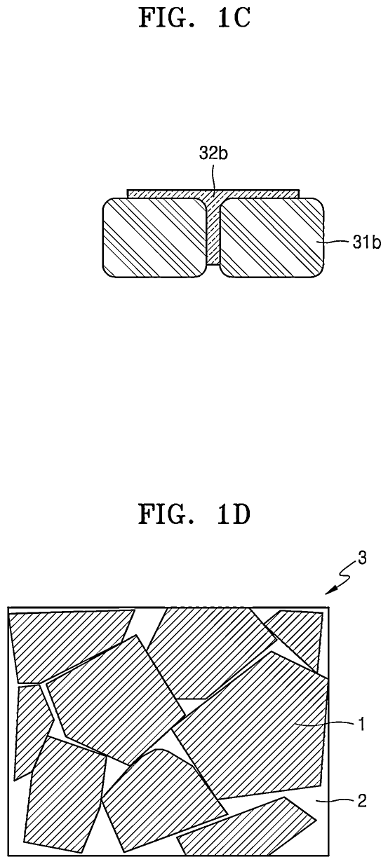

Referring to FIGS. 1A to 1D, a formation process of a composite solid electrolyte according to an embodiment will be described.

A composite solid electrolyte-forming composition may be prepared by mixing an amorphous first solid electrolyte precursor 31 and a glass-phase second solid electrolyte precursor 32. FIG. 1A shows the state of the amorphous first solid electrolyte precursor 31 and the glass-phase second solid electrolyte precursor 32 before heating to a temperature greater than a crystallization temperature of the first solid electrolyte precursor.

If the composition for forming a composite solid electrolyte is heat-treated at a temperature equal to or greater than the crystallization temperature of the first solid electrolyte precursor, as shown in FIG. 1B, the amorphous first solid electrolyte precursor may be crystallized to form a high-conductivity first solid electrolyte 31b having a cubic garnet phase and a pyrochlore phase. Due to a difference in density between the amorphous first solid electrolyte precursor, and the high-conductivity first solid electrolyte having a cubic garnet phase and a pyrochlore phase, when the precursor of the first solid electrolyte crystallizes, a change in volume occurs and pores are formed. The second solid electrolyte precursor having a glass phase, due to having fluidity, may fill the pores as shown in FIG. 1B and lead to improved relative density of the composite solid electrolyte. The second solid electrolyte precursor 32, due to including a halogen atom such as chlorine, fluorine, iodine, or a combination thereof, has an ionic conductivity of 1×10⁻⁶ S/cm or greater, which is relatively greater than that of other glass materials, and thus may contribute to high ionic conductivity of the composite solid electrolyte. In addition, because the second solid electrolyte precursor has little difference in density between the amorphous phase and the crystalline phase, pores may be minimized when crystallized.

Referring to FIG. 1C, as the temperature of the precursor for forming the composite solid electrolyte in FIG. 1B is raised to the crystallization temperature of the second solid electrolyte, a composite solid electrolyte including the high-conductivity first solid electrolyte 31b having a cubic garnet crystalline phase and a pyrochlore phase, and the second solid electrolyte 32b containing a crystalline phase may be formed.

According to another embodiment, a composite solid electrolyte 3 may comprise a high-conductivity first solid electrolyte 1 having a cubic garnet crystalline phase and a pyrochlore phase, and a solid electrolyte 2 having lithium haloboracite containing a crystalline phase. The solid electrolyte 2 has flexibility and may connect between particles of the first solid electrolyte 1 or fill pores of the first solid electrolyte 1. By having such a structure, a composite solid electrolyte having both high conductivity and compactness (i.e., increased density) may be prepared.

In the composite solid electrolyte according to an embodiment, the amount of the first solid electrolyte may be greater than 50 vol % to 99 vol % or less with respect to the total volume of the composite solid electrolyte (the total volume of the first solid electrolyte and the second solid electrolyte).

In the composite solid electrolyte according to an embodiment, the amount of the second solid electrolyte may be less than 50 vol %, 45 vol % or less, or about 1 vol % to about 45 vol %, with respect to the total volume of the composite solid electrolyte. The amount of the second solid electrolyte according to another embodiment may be 10 vol % or less, or about 1 vol % to about 10 vol %. The mixing volume ratio of the first solid electrolyte and the second solid electrolyte may be about 99:1 to about 55:45 (1.2:1), or about 95:5 to about 60:40 (1.5:1). If the amount of the second solid electrolyte is 50 vol % or greater, improvement of ionic conductivity of the composite solid electrolyte may be limited.

If the amount of the second solid electrolyte is in the aforementioned ranges, a composite solid electrolyte which can be sintered at low temperature and has a high room-temperature conductivity of 1×10⁻⁵ S/cm or greater, for example, about 1×10⁻⁵ S/cm to about 1×10⁻³ S/cm, may be prepared.

The first solid electrolyte precursor in an amorphous state prior to heat-treating may have an average particle size of about 10 nm to about 1 μm. The average crystallite size of the crystalline phase of the prepared first solid electrolyte after heat treating the first solid electrolyte precursor may be about 50 nm to about 50 μm, about 100 nm to about 30 μm, or about 500 nm to about 20 μm. As the size of the crystalline phase of the sintered body obtained from heat treating increases, the ionic conductivity of the composite solid electrolyte increases. In particular, if the form of the crystalline phase of the first solid electrolyte is spherical, the average crystallite size of the crystalline phase refers to an average diameter of the crystalline phase; and if the form of the crystalline phase of the first solid electrolyte is non-spherical, the average crystallite size of the crystalline phase refers to an average major axis length. In addition, the average crystallite size of the crystalline phase of the first solid electrolyte may be evaluated through a scanning electron microscopy image.

The composite solid electrolyte may have a relative density of about 80% to about 99.5%, about 90% to about 99.5%, or about 91.5% to about 99.1% based on a theoretical density of the composite solid electrolyte. With the composite solid electrolyte having a relative density within the aforementioned ranges, the composite solid electrolyte shows compactness so that a lithium battery with improved charge and discharge characteristics can be prepared.

The composite solid electrolyte may have a thickness of about 1 μm to about 500 μm, about 1 μm to about 300 μm, or about 3 μm to about 20 μm. With the composite solid electrolyte having a thickness in the aforementioned ranges, a lithium battery having excellent charge and discharge characteristics may be prepared. In the present disclosure, the term “thickness” refers to an average thickness.

A composite solid electrolyte according to an embodiment may have a porosity of about 0.5% to about 20%, or about 0.5% to about 10%, and an average pore size of about 100 nm to about 1,000 nm, or 100 nm to about 500 nm. The composite solid electrolyte having a porosity and an average pore size in the aforementioned ranges may be ensured to have conductivity and compactness. If using this composite solid electrolyte, a lithium battery which can be sintered at low temperature and has improved energy density and improved cycling performance may be provided. In the present disclosure, average pore sizes may be evaluated by a scanning electron microscopy image.

The composite solid electrolyte may have a crystallinity of about 90% to about 100%, about 93% to about 100%, or about 95% to about 100%. With the composite solid electrolyte having a crystallinity in the aforementioned ranges, a lithium battery which can be sintered at low temperature and has improved energy density and improved cycling performance may be provided.

The first solid electrolyte may comprise, for example, a material including Li, La, Zr, Ta, and O. In addition, the second solid electrolyte precursor may comprise a glassy material exhibiting a glass transition behavior, and may include, for example, Li, B, Al, Cl, and O. The first solid electrolyte may have a lithium content greater than a lithium content of a second solid electrolyte precursor. In an embodiment, the second solid electrolyte precursor may have a lithium content greater than a lithium content of the first solid electrolyte.

Heat treating of a first solid electrolyte precursor and a second solid electrolyte precursor to form the composite solid electrolyte may be performed at a temperature greater than a crystallization temperature of a first solid electrolyte and a crystallization temperature of a second solid electrolyte. Following a heat treatment in the aforementioned temperature range, the composite solid electrolyte may include a first solid electrolyte including a cubic garnet phase as main phase and including a pyrochlore phase as a minor phase, and a second solid electrolyte including a crystalline phase. The ratio of the cubic garnet phase to the pyrochlore phase may be about 99.5:0.5 to about 3:2.

The first solid electrolyte may include, for example, a compound represented by Formula 1.

(LiₓAₐ)(La_{y}B′_{b})(Zr_{z}C′_{c})O₁₂ Formula 1

In Formula 1, A may be a monovalent cation, a divalent cation, a trivalent cation, or a combination thereof, B′ may be a monovalent cation, a divalent cation, a trivalent cation, or a combination thereof, C′ may be a monovalent cation, a divalent cation, a trivalent cation, a tetravalent cation, a pentavalent cation, a hexavalent cation, or a combination thereof, and 5≤x≤7, 0≤a≤2, 2≤y≤3, 0≤b≤1, 0<z≤2, and 0≤c≤2.

In Formula 1, A, B′, and C′ as a monovalent cation may include Li, Na, K, or a combination thereof. Examples of the divalent to hexavalent cations include Mg, Ca, Sr, Sc, Y, La, Ce, Pr, Nd, Sm, Eu, Gd, Tb, Dy, Ho, Er, Tm, Yb, Lu, Zr, Hf, V, Nb, Ta, Mo, W, Mn, Tc, Re, Fe, Ru, Os, Co, Rh, Ir, Ni, Pd, Pt, Cu, Ag, Au, Zn, Cd, Hg, Al, Ga, In, TI, Ge, Sn, Pb, Sb, Bi, Po, As, Se, Te, or a combination thereof.

In Formula 1, the relation 5.1≤x≤7, 6.3≤x≤7, 6.5≤x≤7, or 6.7≤x≤7 may be satisfied, and the relation 0≤a≤2, 0.5≤a≤1.8, 0.7≤a≤1.8, or 1≤a≤2 may be satisfied.

In Formula 1, the relation 2≤y≤3, 2.3≤y≤3, 2.5≤y≤3, or 2.7≤y≤3 may be satisfied, and the relation 0≤b≤1, 0.3≤b≤1, 0.5≤b≤1, or 0.7≤b≤1 may be satisfied.

In Formula 1, the relation 0<z≤2, 0.3≤z≤2, 0.5≤z≤2, or 0.7≤z≤2 may be satisfied, and the relation 0≤c≤2, 0.3≤c≤2, 0.5≤c≤2, or 0.7≤c≤2 may be satisfied.

An embodiment of a composite solid electrolyte may include a garnet-type crystalline phase and a pyrochlore phase, and when the composite solid electrolyte is analyzed by XRD using Cu Kα radiation, peaks may appear at diffraction angles of 16.8°2θ±0.5°2θ, 17.5°2θ to 19°2θ, 26°2θ to 28°2θ, 33°2θ to 34°2θ, and 46°2θ to 48°2θ. Also, when the composite solid electrolyte is analyzed by XRD using Cu Kα radiation, peaks may appear at diffraction angles of 27.5°2θ to 29°2θ, 32°2θ to 33.5°2θ, 46.5°2θ to 48°2θ, and 55°2θ to 56.5°2θ. In general, the peaks observed at a diffraction angle of 16.8°2θ±0.5°26, 17.5°2θ to 19°2θ, 26°2θ to 28°2θ, 33°2θ to 34°2θ, and 46°2θ to 48°2θ are peaks associated with a cubic garnet phase, and the peaks observed at a diffraction angle 27.5°2θ to 29°2θ, 32°2θ to 33.5°2θ, 46.5°2θ to 48°2θ, and 55°2θ to 56.5°2θ are peaks associated with a pyrochlore phase.

A composite solid electrolyte according to an embodiment may be in a state free of a tetragonal phase. In an XRD spectrum of the solid electrolyte in this state, the peak at a diffraction angle 16.8°2θ±0.5°2θ may have a singlet state.

As described previously, the composite solid electrolyte may have improved deformability characteristics and may be formable into various shapes at low temperatures. Further, the composite solid electrolyte, due to being formable at low temperatures, may reduce structural deformations when coupled to structures, e.g., electrodes, and may stabilize interfacial characteristics between the composite solid electrolyte and the electrode structures.

In the composite solid electrolyte, the amount or mixing ratio of a cubic garnet phase and a pyrochlore phase may be directly or indirectly confirmed by XRD analysis or TEM/SAED (selected area electron diffraction). Through the XRD analysis, the predominantly maintained crystalline phase may be selected and subjected to an XRD Rietveld analysis to determine the mixing ratio of each crystalline phase.

A composite solid electrolyte according to an embodiment, by including a cubic garnet phase, a pyrochlore phase, and lithium haloboracite, may further facilitate lithium transfer within the solid electrolyte, compared to a solid electrolyte including a cubic garnet phase alone.

A composite solid electrolyte according to an embodiment may comprise a cubic garnet phase, which is a crystalline phase, wherein the amount of the cubic garnet phase may be 60 wt % or greater, 70 wt % or greater, 80 wt % or greater, about 80 wt % to about 99 wt %, or about 90 wt % to about 99.5 wt %, with respect to the total amount of the cubic garnet phase and pyrochlore phase, and the remaining phase may be a phase not containing lithium, such as a pyrochlore phase. For example, the pyrochlore phase may be La₂₊ₓZr₂₍₁₋ₓ₎TaₓO₇ (0≤x≤0.5). The amount of the pyrochlore phase may be about 0.5 wt % to about 10 wt %, about 1 wt % to about 5 wt %, or about 1 wt % to about 3 wt %, with respect to the total amount of the cubic garnet phase and the pyrochlore phase.

If the amount of the cubic garnet phase is within the aforementioned ranges, the composite solid electrolyte may have excellent ionic conductivity. If the amount of the cubic garnet phase is within the aforementioned ranges, it may be possible to obtain a solid electrolyte that has high ionic conductivity in various temperature ranges and has low interfacial resistance with a cathode or anode when preparing a lithium battery.

A composite solid electrolyte according to an embodiment may have an ionic conductivity of 1×10⁻⁶ S/cm or greater, for example, about 1×10⁻⁶ S/cm to about 1×10⁻³ S/cm, and may be characterized by compactness even without undergoing a high-temperature sintering process, and thus may have excellent relative density of 80% or greater, for example, about 85% to about 99.5%. In the present disclosure, the term “relative density” refers to a density calculated by measuring the dimensions (diameter, thickness) and mass of a sintered body. In addition, relative densities may be obtained by using a pycnometer and the theoretical density of LLZO (5.14 grams per cubic centimeter, g/cm³).

A composite solid electrolyte according to an embodiment may be electrochemically stable at a voltage of 3.0 volts (V) or greater (vs. Li metal), or at about 3.0 V to about 4.5 V (vs. Li metal).

The first solid electrolyte may comprise a compound represented by Formula 2, a compound represented by Formula 3, or a combination thereof.

Liₓ(La_{y}B′_{b})(Zr_{z}C′_{c})O₁₂ Formula 2

In Formula 2, B′ may be calcium (Ca), strontium (Sr), cesium (Ce), barium (Ba), or a combination thereof, C′ may be aluminum (Al), tungsten (W), niobium (Nb), tantalum (Ta), or a combination thereof, and 5≤x≤7, 2≤y≤3, 0<z≤2, 0<b≤1, and 0.01≤c≤2.

(LiₓAₐ)(La_{y})(Zr_{z})O₁₂ Formula 3

In Formula 3, A may be Ga, Al, or a combination thereof, and 5≤x≤7, 0≤a≤2, 2≤y<3, and 0<z≤2.

The first solid electrolyte may be, for example, a compound represented by Formula 4.

Liₓ(La_{y}B′_{b})(Zr_{z}C′_{c})O₁₂ Formula 4

In Formula 4, B′ may be calcium (Ca), strontium (Sr), cesium (Ce), barium (Ba), or a combination thereof, C may be aluminum (Al), tungsten (W), niobium (Nb), tantalum (Ta), or a combination thereof, and 5≤x≤7, 2≤y≤3, 0<z≤2, 0.01≤c≤2, and 0<b≤1

According to an embodiment, the first solid electrolyte may be, for example, Li₇La₃Zr₂O₁₂ (LLZO), Li_{6.5}La₃Zr_{1.5}Ta_{0.5}O₁₂, Li_{6.5}La₃Zr_{1.5}Nb_{0.5}O₁₂, Li_{6.25}La₃Zr₂Al_{0.25}O₁₂, or the like.

According to another embodiment, the first solid electrolyte may be, for example, LiₓLa₃M₂O₁₂ (5≤x≤7, M is Ta, Nb, or Zr), LiₓLa₃Zr_{2-α}M_{α}O₁₂ (5≤x≤7, M is Ta or Nb), Li_{6.24}La₃Zr₂Al_{0.24}O₁₂, Li₇La₃Zr_{1.7}W_{0.3}O₁₂, Li₇La₃Zr_{1.7}W_{0.3}O₁₂, Li_{4.9}La_{2.5}Ca_{0.5}Zr_{1.7}Nb_{0.3}O₁₂, Li_{6.4}La₃Zr_{1.7}W_{0.3}O₁₂, Li₇La₃Zr_{1.5}W_{0.5}O₁₂, Li₇La_{2.75}Ca_{0.25}Zr_{1.75}Nb_{0.25}O₁₂, Li₇La₃Zr_{1.5}Nb_{0.5}O₁₂, Li₇La₃Zr_{1.5}Ta_{0.5}O₁₂, Li₇La_{2.75}Ca_{0.25}Zr_{1.75}Nb_{0.25}O₁₂, Li_{6.272}La₃Zr_{1.7}W_{0.3}O₁₂, or the like.

The second solid electrolyte may be an oxide glass-type lithium-ion conductor including chlorine with an ionic conductivity greater than that of other glass-type materials not including chlorine. As a result, the composite solid electrolyte including the second solid electrolyte may maintain high ionic conductivity.

The second solid electrolyte may include, for example, a compound represented by Formula 5.

Liₐ(BₓM_{y}N_{z})O_{b}X_{c} Formula 5

In Formula 5, 4≤a≤7, 12≤b≤13, 0<c≤1, 0<x≤7, 0≤y≤3, 0≤z≤1, and 6≤x+y+z≤7,
M and N each independently may be Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, W, or a combination thereof, and
X may be Cl, Br, I, or a combination thereof.

The second solid electrolyte may be, for example, a compound represented by Formula 5-1.

Liₐ(BₓM_{y}N_{z})O_{b}Cl_{c} Formula 5-1

In Formula 5-1, 4≤a≤7, 12≤b≤13, 0<c≤1, 0<x≤7, 0≤y≤3, 0≤z≤1, and 6≤x+y+z≤7, and M and N each independently may be Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, W, or a combination thereof.

M may be, for example, Al, Ga, or a combination thereof, and N may be selected differently from M, for example, N may be Fe.

The relations 4≤x≤7 or 5≤x≤7, and 0≤y≤3 or 0≤y≤1 may be satisfied.

The second solid electrolyte may be, for example, Li₄B₇O₁₂Cl, Li₄B₄Al₃O₁₂Cl, Li₄B₄Ga₃O₁₂Cl, Li₄B₅AlFeO₁₂Cl, or a combination thereof.

### Method of Preparing Composite Solid Electrolyte

A composite solid electrolyte may be prepared by mixing a first solid electrolyte precursor having an amorphous phase with a second solid electrolyte precursor having a glass phase to prepare a composite solid electrolyte-forming composition, and then heat-treating the composite solid electrolyte-forming composition to prepare the composite solid electrolyte.

The heat treatment may be performed at a temperature greater than a crystallization temperature of a first solid electrolyte and a crystallization temperature of a second solid electrolyte. For example, the heat treatment of the composite solid electrolyte-forming composition may be performed, for example, at a temperature of 600° C. or less, 550° C. or less, for example, about 350° C. to about 550° C., about 380° C. to about 550° C., about 400° C. to about 550° C., or about 450° C. to about 550° C.

During the heat treating, the amorphous first solid electrolyte precursor may undergo crystallization to form a first solid electrolyte having a cubic garnet phase and a pyrochlore phase, and the glass-phase second solid electrolyte precursor, due to having a glass transition temperature near a crystallization temperature of the first solid electrolyte precursor, gains fluidity and thus may serve to connect particles of the first solid electrolyte particles having a crystalline phase. In addition, pores generated by crystallization of the first solid electrolyte may be filled by the second solid electrolyte precursor having fluidity, and because the second solid electrolyte in the composite solid electrolyte has a structure including a crystalline phase, the composite solid electrolyte may comprise a composite crystalline-phase structure. In addition, because the composite solid electrolyte includes crystalline particles of the first solid electrolyte, the composite solid electrolyte may include crystalline particles of a smaller size than that of commercially available crystalline first solid electrolytes. As the first solid electrolyte precursor having an amorphous phase is crystallized, the first solid electrolyte may form a dense interface with the second solid electrolyte. As a result, the composite solid electrolyte may have improved conductivity and compactness.

The second solid electrolyte precursor may exhibit a glass transition behavior and have a glass transition temperature of 450° C. or less, for example, about 350° C. to about 450° C. The glass transition behavior may be identified through differential scanning calorimetry analysis. If the second solid electrolyte precursor has a glass transition temperature in the aforementioned ranges, excellent deformability may be provided during a press heat treatment process, and relative density of the composite solid electrolyte may be increased while maintaining high ionic conductivity after a heat treatment with pressure.

The composite solid electrolyte following a heat treatment may include a first solid electrolyte having a cubic garnet phase and a pyrochlore phase. The cubic garnet phase may originate from an amorphous first solid electrolyte precursor. The pyrochlore phase may be caused by an amorphous first solid electrolyte precursor, or may be caused by a reaction between an amorphous first solid electrolyte precursor and a glass-phase second solid electrolyte precursor.

The amorphous first solid electrolyte precursor may be used as a starting material for the first solid electrolyte having a cubic garnet phase and a pyrochlore phase. Accordingly, the type and amount of elements in the first solid electrolyte precursor may be substantially the same as, or similar to the type and amount of elements in the first solid electrolyte having a cubic garnet phase and a pyrochlore phase. For example, the first solid electrolyte precursor having an amorphous phase may include a compound represented by Formula 1.

(LiₓAₐ)(La_{y}B′_{b})(Zr_{z}C′_{c})O₁₂ Formula 1

In Formula 1, A may be a monovalent cation, a divalent cation, a trivalent cation, or a combination thereof, B′ may be a monovalent cation, a divalent cation, a trivalent cation, or a combination thereof, C′ may be a monovalent cation, a divalent cation, a trivalent cation, a tetravalent cation, a pentavalent cation, a hexavalent cation, or a combination thereof, and 5≤x≤7, 0≤a≤2, 2≤y≤3, 0≤b≤1, 0<z≤2, and 0≤c≤2.

The first solid electrolyte precursor having an amorphous phase may include a compound represented by Formula 2 or 3 mentioned with respect to the first solid electrolyte, or a combination thereof.

Liₓ(La_{y}B′_{b})(Zr_{z}C′_{c})O₁₂ Formula 2

In Formula 2, B′ may be calcium (Ca), strontium (Sr), cesium (Ce), barium (Ba), or a combination thereof, C′ may be aluminum (Al), tungsten (W), niobium (Nb), tantalum (Ta), or a combination thereof, 5≤x≤7, 2<y≤3, 0<z≤2, 0<b≤1, and 0.01≤c≤2.

(LiₓAₐ)(La_{y})(Zr_{z})O₁₂ Formula 3

In Formula 3, A may be Ga, Al, or a combination thereof, 5≤x≤7, 0≤a≤2, 2≤y≤3, and 0<z≤2.

The first solid electrolyte precursor having an amorphous phase may include a compound represented by Formula 4 described with respect to the first solid electrolyte.

Liₓ(La_{y}B′_{b})(Zr_{z}C′_{c})O₁₂ Formula 4

In Formula 4, B′ may be calcium (Ca), strontium (Sr), cesium (Ce), barium (Ba), or a combination thereof, C′ may be aluminum (Al), tungsten (W), niobium (Nb), tantalum (Ta), or a combination thereof, 5≤x≤7, 2<y≤3, 0<z≤2, 0.01≤c≤2, and 0<b≤1.

The second solid electrolyte precursor may be, for example, a compound of Formula 5.

Liₐ(BₓM_{y}N_{z})O_{b}X_{c} Formula 5

In Formula 5, 4≤a≤7, 12≤b≤13, 0<c≤1, 0<x≤7, 0<y≤3, 0≤z≤1, and 6≤x+y+z≤7, M and N each independently may be Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, W, or a combination thereof, and X is Cl, Br, I, or a combination thereof.

The second solid electrolyte precursor may be, for example, a compound of Formula 5-1.

Liₐ(BₓM_{y}N_{z})O_{b}Cl_{c} Formula 5-1

In Formula 5-1, 4≤a≤7, 12≤b≤13, 0<c≤1, 0<x≤7, 0≤y≤3, 0≤z≤1, and 6≤x+y+z≤7, M and N each independently may be Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, W, or a combination thereof.

The composite solid electrolyte-forming composition may further include a precursor containing C′ element of Formula 1, wherein the precursor containing C′ element may include a tantalum precursor, an aluminum precursor, a tungsten precursor, a niobium precursor, or a combination thereof.

The first solid electrolyte precursor having an amorphous phase may be prepared by mixing a first solid electrolyte forming-precursor to prepare a mixture, and then mechanochemically synthesizing the mixture.

For example, the first solid electrolyte precursor having an amorphous phase may be prepared by mixing a mixture of a lithium precursor, a lanthanum precursor, a zirconium precursor, and a C′-containing precursor, and mechanochemically synthesizing the mixture.

The lanthanum precursor, the zirconium precursor, and the precursor containing C′ element may utilize an oxide, a sulfate, or a chloride, containing lanthanum, zirconium, and a C′ element, respectively, or a combination thereof.

Examples of the lanthanum precursor may include La₂O₃, LaCl₃, or the like, and examples of the zirconium precursor may include ZrO₂, ZrCl₂, or the like. In addition, examples of the tantalum precursor may include Ta₂O₅, TaCl₅, or the like.

Examples of the lithium precursor may include Li₂O, LiCl, LiOH, Li₂(CO₃), or the like. The lanthanum precursor, the zirconium precursor, and the C′ precursor containing C′ element, and the lithium precursor may each be used in an amount appropriate for the composition of an amorphous first solid electrolyte.

The heat treatment of the mixture may be performed in atmospheric air or in an oxygen atmosphere, at a temperature of about 1,000° C. to about 1,500° C., about 1,100° C. to about 1,500° C., 1,100° C. to about 1,400° C., 1,200° C. to about 1,400° C., or about 1,200° C. to about 1,350° C.

The heat treatment of the mixture may be a solid-state reaction, and the heat treatment time may be, for example, about 5 hours to about 50 hours, for example, about 10 hours to about 50 hours.

The mechanochemical synthesis may include mechanical milling and the like. The mechanical milling may include, for example, high energy mechanical milling. The high-energy mechanical milling refers to a process of forming materials into a complex by application of mechanical energy, and by applying a high energy to reactants through high rotational force, can atomize powder as well as induce a chemical reaction in the reactants through maximized dispersion force between powder particles. The high-energy mechanical milling may be achieved by Mechanofusion system or a Nobilta device, or the like, and Mechanofusion may be a method of forming a mixture through strong physical rotational force in a dry state, which creates electrostatic adhesion force between constitutive components. Through this process, it may be possible to atomize particles and obtain particle powder characterized by uniform distribution. The average particle diameter of the particles may be about 1 nm to about 100 μm, about 3 nm to about 100 μm, about 5 nm to about 100 μm, or about 5 nm to about 80 μm.

The high-energy ball milling may be performed by, for example, a vibratory-mill, a Z-mill, a planetary ball-mill, an attrition-mill, a SPEX mill, a vibratory mill, a low-temperature grinder, a friction mill, a shaker mill, a stirring ball mill, a mixer ball mill, vertical and horizontal attritors, or the like, and the high-energy ball milling may be performed by any ball milling device available for high-energy ball milling in the art.

Examples of the high-energy ball milling device may include, but are not limited to, commercially available devices, for example, SPEX CertiPrep Group LLC (8000 M Mixer/Mill®, etc.), Zoz GmbH (Simoloyer®), Retsch GmbH (Planetary Ball Mill PM) 200/400/400 MA), Union Process Inc. (Attritor®), and a Pulverisette 7 Premium line device. Such high-energy mechanical milling may significantly reduce the size of the first solid electrolyte having a garnet crystal structure, and facilitate reactions between these particles, such that the composite solid electrolyte may be prepared within a short time.

The grinding balls used during high-energy ball-milling may be stainless steel beads or zirconia beads (ZrO₂), which may have a particle size in a range of about 0.5 millimeters (mm) to about 20 mm, without being limited thereto. The pulverization time by high-energy ball-milling in step (A) may be about 0.5 hours to about 150 hours.

Through such high-energy mechanical milling, the size of constitutive components of the mixture may become significantly smaller, facilitating reactions between these components such that the first solid electrolyte may be prepared within a short time. Due to the high-energy mechanical milling, the particles may have a sub-micrometer size of 1 μm or less, for example, about 10 nm to about 1 μm, about 20 μm to about 900 nm, or about 30 nm to about 500 nm.

The high-energy mechanical milling may be performed in an inert atmosphere, and the inert atmosphere may be an atmosphere that is substantially free of oxygen. For example, the inert atmosphere may be an atmosphere containing nitrogen, argon, neon, or a combination thereof. The mechanochemical reaction may be, for example, an exothermic reaction. The reaction that forms a solid electrolyte may be an exothermic reaction. A temperature of the exothermic reaction may be, for example, about 100° C. to about 500° C., about 100° C. to about 400° C., about 100° C. to about 300° C., or about 100° C. to about 200° C. Mechanical milling may be performed, for example, by a dry method without using solvents or the like. As the mechanical milling is performed by a dry method, post-treatment processes such as solvent removal, may be omitted.

According to an embodiment, the high-energy mechanical milling may be performed, for example, in an inert atmosphere in a dry manner at a rate of about 300 revolutions per minute (rpm) to about 10,000 rpm, about 350 rpm to about 5,000 rpm, or about 370 rpm to about 1,000 rpm, and may be performed for about 10 hours to about 30 hours. The high-energy mechanical milling may be performed, for example, in an inert atmosphere in a dry manner at a rate of about 300 rpm to about 10,000 rpm, about 350 rpm to about 5,000 rpm, or about 370 rpm to about 1,000 rpm, and may be performed for about 0.5 hours to about 150 hours.

Prior to heat treating a composite solid electrolyte forming-composition including a first solid electrolyte precursor having an amorphous state and a second solid electrolyte precursor having a glass phase, mechanical milling may be further performed. The mechanical milling may include high-energy mechanical milling. The mechanical milling is as described above.

During high-energy mechanical milling, an organic solvent may be added if necessary. By performing bead-mill pulverization within an organic solvent, the pulverized products may prevent dissolution of lithium (Li) components, and a fine pulverized product having a uniform composition may be obtained.

The organic solvent may be an alcohol-based solvent, a ketone-based solvent, an ester-based solvent, a glycol ether-based solvent, a hydrocarbon-based solvent, an ether solvent, a glycol-based solvent, an amine-based solvent, or a combination thereof. For example, the organic solvent may be an alcohol-based solvent, such as isopropyl alcohol, toluene, methanol, ethanol, butanol, hexanol, benzyl alcohol, or isopropyl alcohol; a ketone-based solvent, such as acetone, methyl ethyl ketone, methyl isobutyl ketone, or cyclohexanone; an ester-based solvent, such as methyl acetate, ethyl acetate, or butyl acetate; a glycol ether-based solvents, such as propylene glycol monomethyl ether, ethylene glycol monoethyl ether, ethyl glycol monobutyl ether, 3-methoxy-3-methyl-1-butanol, or diethylene glycol monobutyl ether; a hydrocarbon-based solvents, such as benzene, toluene, xylene, cyclohexane, methylcyclohexane, ethylcyclohexane, mineral oil, n-paraffin, or iso-paraffin; an ether solvent, such as 1,3-dioxolane, 1,4-dioxane, or tetrahydrofuran; a glycol-based solvent, such as ethylene glycol, diethylene glycol, propylene glycol, or polyethylene glycol; an amine-based solvent, such as monoethanolamine, diethylamine, triethanolamine, n-methyl-2-pyrrolidone, 2-amino-2-methyl-1-propanol, or N, N-dimethylformamide, or a combination thereof. If water, which has high hydrophilicity, is used as the solvent, lithium (Li) is dissolved, which may cause degradation of LLZO crystallinity. However, the aforementioned organic solvents have high hydrophobicity such that they do not dissolve lithium (Li) and thus make it easier to maintain LLZO crystallinity. For example, by using toluene as the organic solvent, the formation of impurity phases may be further suppressed.

### Lithium Battery

A lithium battery according to another embodiment may include: a cathode; an anode; and an electrolyte layer disposed between the cathode and the anode, wherein the cathode, the anode, the electrolyte layer, or a combination thereof may include a composite solid electrolyte according to an embodiment. As the lithium battery includes the aforementioned composite solid electrolyte, the lithium battery may have reduced internal resistance and improved cycling performance. The lithium battery is not particularly limited and may be, for example, a lithium ion battery, an all-solid battery, a lithium air battery, or the like. The all-solid secondary battery may be, for example, a multilayer ceramic (MLC) battery.

According to an embodiment, the cathode may include, for example, a composite solid electrolyte. In addition, if a lithium battery is prepared using the composite solid electrolyte, highly uniform interfacial characteristics between the solid electrolyte and the cathode may be ensured.

These batteries will be described in greater detail below.

### Lithium-Ion Battery

The lithium-ion battery may be, for example, a lithium battery including a liquid electrolyte. A lithium-ion battery may include a composite solid electrolyte according to an embodiment.

A lithium-ion battery may include, for example, a cathode containing a cathode active material; an anode containing an anode active material; and a liquid electrolyte disposed between the cathode and the anode, wherein the cathode, the anode, or a combination thereof may include a composite solid electrolyte according to an embodiment. A lithium-ion battery may include, for example, a cathode, an anode, and a liquid electrolyte disposed between the cathode and the anode, wherein a protective layer including a composite solid electrolyte according to an embodiment may be disposed on a side of the cathode, the anode, or a combination thereof. A lithium-ion battery may include, for example, a cathode active material layer, wherein the cathode active material layer may include a core including a cathode active material; and a composite cathode active material including a first coating layer disposed on the core, wherein the first coating layer may include a composite solid electrolyte according to an embodiment. A lithium-ion battery may include, for example, an anode active material layer, wherein the anode active material layer may include a composite anode active material including a core including an anode active material; and a second coating layer disposed on the core, wherein the second coating layer may include a composite solid electrolyte according to an embodiment.

### All-Solid Secondary Battery

An all-solid secondary battery may include a composite solid electrolyte according to an embodiment.

The all-solid secondary battery may include a cathode; an anode; and a solid electrolyte layer disposed between the cathode and the anode, wherein the cathode, the anode, the solid electrolyte layer, or a combination thereof may include a composite solid electrolyte according to an embodiment.

### Type 1: All-Solid Secondary Battery Employing Non-Plated Type Anode

FIG. 3 is a schematic cross-sectional diagram illustrating an embodiment of an all-solid secondary battery including a non-plated type anode. In the all-solid secondary battery including a non-plated type anode, during the initial charging, the initial charge capacity of the anode active material layer may be, for example, greater than 50%, 60% or greater, 70% or greater, 80% or greater, 90% or greater, or 100% or greater, with respect to the initial charge capacity of the cathode active material layer.

An all-solid secondary battery may be prepared as follows.

First, a solid electrolyte layer may be prepared. The solid electrolyte layer may include a composite solid electrolyte according to an embodiment. The solid electrolyte layer may be prepared, for example, by coating a composite solid electrolyte forming-composition to provide a coated composition and drying the coated composition to provide a solid electrolyte layer, or the solid electrolyte layer may be prepared by preparing a composite solid electrolyte forming-composition in a powder form, and pressing the same.

The composite solid electrolyte forming-composition may include a binder. Examples of the binder may styrene butadiene rubber (SBR), polytetrafluoroethylene, polyvinylidene fluoride, polyethylene, polyvinyl alcohol, or the like. However, without being limited to the aforementioned examples, any binder available in the art may be used. The binder in the solid electrolyte layer may be the same as or different from the binders in the cathode and the anode.

When preparing the solid electrolyte layer, other than the composite solid electrolyte according to an embodiment, an oxide solid electrolyte, a sulfide solid electrolyte, or a combination thereof may be further included.

Next, a cathode may be prepared.

The cathode may include a composite solid electrolyte including a first solid electrolyte including a cubic garnet phase and a pyrochlore phase, and a second solid electrolyte including lithium haloboracite. A volume of the first solid electrolyte may be greater than a volume of the second solid electrolyte.

The cathode may be prepared by forming, on a cathode current collector, a cathode active material layer including a cathode active material. The cathode active material layer may be prepared by a vapor-state reaction method or a solid-state reaction method. The vapor-state reaction method may include methods such as pulse laser deposition (PLD), sputtering deposition, and chemical vapor deposition (CVD), but without being limited to the aforementioned methods, any method available in the art may be used. The solid-state reaction method may include methods such as sintering, a sol-gel technique, a doctor blade technique, screen printing, slurry casting, and powder pressing, but without being limited to the aforementioned methods, any method available in the art may be used.

As a cathode active material, a compound capable of reversible intercalation and deintercalation of lithium (lithiated intercalation compound) may be used. Specifically, one or more composite oxides of lithium with a metal selected from cobalt, manganese, nickel, or a combination thereof, may be utilized. The composite oxides may be a lithium transition metal composite oxide, examples of which include a lithium nickel oxide, a lithium cobalt oxide, a lithium manganese oxide, a lithium iron phosphate compound, a cobalt-free nickel-manganese oxide, or a combination thereof. As an example, a compound represented by any of the following formulas may be used: LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<a<2); LiₐNi_{b}Co_{c}L¹_{d}GeO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}GbO₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂ (PO₄)₃ (0≤f≤2); and LiₐFePO₄ (0.90≤a≤1.8). In the above formulas, A may be Ni, Co, Mn, or a combination thereof; X may be Al, Ni, Co, Mn, Cr, Fe, Mg, Sr, V, a rare-earth element, or a combination thereof; D may be O, F, S, P, or a combination thereof; G may be Al, Cr, Mn, Fe, Mg, La, Ce, Sr, V, or a combination thereof; and L¹ may be Mn, Al, or a combination thereof.

The cathode active material layer may further include a binder, a conductive material, and the like. Examples of the binder include but are not limited to, polyvinyl alcohol, carboxymethyl cellulose, hydroxypropyl cellulose, diacetyl cellulose, polyvinyl chloride, carboxylated polyvinyl chloride, polyvinyl fluoride, ethylene oxide-containing polymers, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, nylon, or the like. Examples of the conductive material include carbon-containing materials, such as natural graphite, artificial graphite, carbon black, acetylene black, Ketjen black, carbon fibers, carbon nanofibers, or carbon nanotubes; metal materials in the form of metal powder or metal fibers including copper, nickel, aluminum, silver, or the like; conductive polymers such as polyphenylene derivatives; or a mixture thereof.

As a cathode current collector, Al may be used, but the present disclosure is not limited thereto.

Next, an anode may be prepared. The anode may be prepared in the same manner as the cathode, except that an anode active material is used in place of the cathode active material. The anode may be prepared by forming, on an anode current collector, an anode active material layer including an anode active material.

The anode active material may include a material capable of reversible intercalation/deintercalation of lithium ions, lithium metal, an alloy of lithium metal, a material capable of doping and dedoping lithium, or a transition metal oxide.

Examples of the material capable of reversible intercalation/deintercalation of lithium ions include carbon-containing anode active materials, such as crystalline carbon, amorphous carbon, or a combination thereof. Examples of the crystalline carbon include graphite, such as artificial graphite or natural graphite in shapeless, plate, flake, spherical or fiber form. Examples of the amorphous carbon include soft carbon or hard carbon, mesophase pitch carbides, calcined cokes, or the like.

Examples of the alloy of lithium metal include alloys of lithium with a metal selected from Na, K, Rb, Cs, Fr, Be, Mg, Ca, Sr, Si, Sb, Pb, In, Zn, Ba, Ra, Ge, Al, and Sn.

Examples of the material capable of doping and dedoping lithium include a Si-based anode active material or a Sn-based anode active material. The Si-based anode active material may be silicon, a silicon-carbon composite, SiOₓ (0<x<2), a Si-Q alloy (wherein Q is an alkali metal an, alkaline-earth metal, a Group 13 element, a Group 14 element (excluding Si), a Group 15 element, a Group 16 element, a transition metal, a rare-earth element, or a combination thereof), or a combination thereof. The Sn-based anode active material may be Sn, SnO₂, a Sn-based alloy, or a combination thereof.

The anode active material layer may further include a binder, a conductive material, and the like. The binder and conductive material may be selected from the aforementioned materials used in the cathode active material layer.

Referring to FIG. 3, an all-solid secondary battery 40 may include a solid electrolyte layer 30, a cathode 10 disposed on one side of the solid electrolyte layer 30, and an anode 20 disposed on the other side of the solid electrolyte layer 30. The cathode 30 may include a cathode active material layer 12 in contact with the solid electrolyte layer 30, and a cathode current collector 11 in contact with the cathode active material layer 12. The anode 20 may include an anode active material layer 22 in contact with the solid electrolyte layer 30, and an anode current collector 21 in contact with the anode active material layer 22. For the all-solid secondary battery 40, for example, the cathode active material layer 12 and the anode active material layer 22 may be formed on each side of the solid electrolyte layer 30, and the cathode current collector 11 and the anode current collector 21 may be formed on the cathode active material layer 12 and the anode active material layer 22, respectively, to provide an all-solid type secondary battery 30. Alternatively, the anode active material layer 22, the solid electrolyte layer 30, the cathode active material layer 12, and the cathode current collector 11 may be sequentially laminated on the anode current collector 21 to provide the all-solid secondary battery 40.

### Type 2: All-Solid Secondary Battery Employing Plated-Type Anode

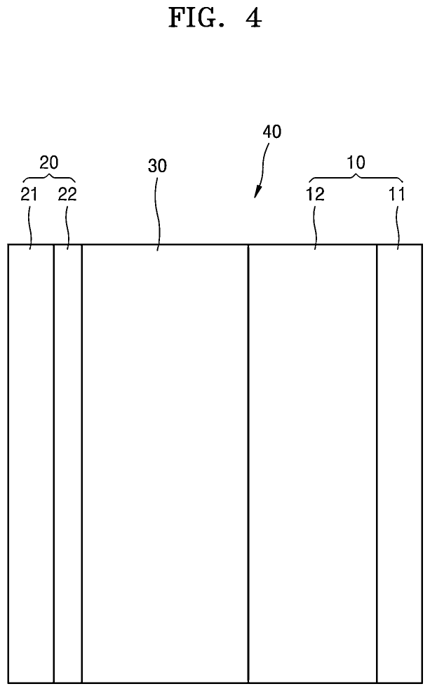

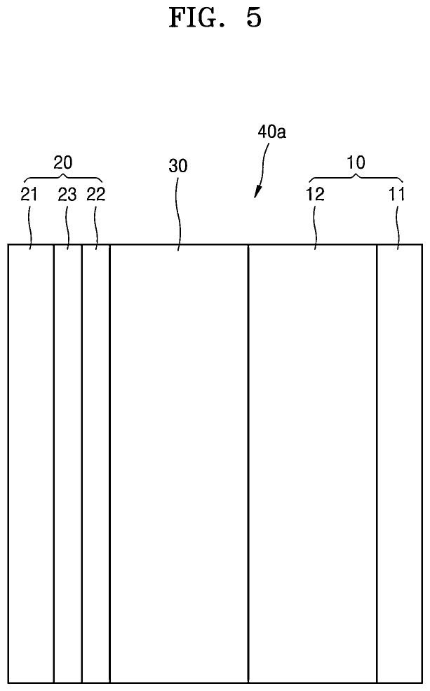

FIGS. 4 and 5 are schematic cross-sectional diagrams of embodiments of an all-solid secondary battery including a plated-type anode. The all-solid secondary battery 40 may include, for example, a cathode 10 including a cathode active material layer 12 disposed on a cathode current collector 11; an anode 20 including an anode active material layer 12 disposed on an anode current collector 21; and an electrolyte layer 30 disposed between the cathode 10 and the anode 20, wherein the cathode active material layer 12 and/or the solid electrolyte layer 30 may include a composite solid electrolyte according to an embodiment.

Referring to FIGS. 4 and 5, the anode 20 may include the anode current collector 21 and the anode active material layer 22 disposed on the anode current collector 21, wherein the anode active material layer 22 may include, for example, an anode active material and a binder.

The anode active material included in the anode active material layer 22 may have, for example, a particulate form. The average particle diameter of the anode active material having a particulate form may be, for example, 4 μm or less, about 10 nm to about 4 μm, about 10 nm to about 3 μm, about 10 nm to about 2 μm, about 10 nm to about 1 μm, or about 10 nm to about 900 nm. With the anode active material having an average particle diameter within the above ranges, reversible absorption and/or desorption of lithium during charging and discharging may be facilitated. The average particle diameter of the anode active material may be, for example, a median particle diameter (D50) as measured by a laser-type particle size distribution analyzer.

The anode active material included in the anode active material layer 22 may include, for example, a carbon-containing anode active material, a metal or metalloid anode active material, or a combination thereof.

The carbon-containing anode active material may utilize, for example, amorphous carbon, and examples of the amorphous carbon include carbon black (CB), acetylene black (AB), furnace black (FB), Ketjen black (KB), graphene, or the like. However, without being limited to the aforementioned examples, any material categorized as amorphous carbon in the art may be used.

The metal or metalloid anode active materials may include gold (Au), platinum (Pt), palladium (Pd), silicon (Si), silver (Ag), aluminum (Al), bismuth (Bi), tin (Sn), zinc (Zn), or a combination thereof. The anode active material included in the anode active material layer 22 may include, for example, a mixture of first particles and second particles, the first particles being composed of amorphous carbon, and the second particles being composed of a metal or a metalloid. The amount of the second particles may be about 8 wt % to about 60 wt %, about 10 wt % to about 50 wt %, about 15 wt % to about 40 wt %, or about 20 wt % to about 30 wt %, with respect to the total weight of the mixture. If the amount of the second particles is within the aforementioned ranges, the all-solid secondary battery 40 may have, for example, further improved cycling performance.

The binder included in the anode active material layer 22 may be, for example, styrene-butadiene rubber (SBR), polytetrafluoroethylene, polyvinylidene fluoride, a polyvinylidene fluoride-hexafluoropropylene copolymer, polyethylene oxide polyacrylonitrile, polymethyl methacrylate, carboxymethyl cellulose, hydroxypropylmethyl cellulose, methyl cellulose, or an alkali metal salt of the aforementioned components. However, without being limited to the aforementioned examples, any binder available in the art may be used. Because the anode active material layer 22 includes a binder, the anode active material layer 22 may be stabilized on the anode current collector 21. Further, crack formation in the anode active material layer 22 may be suppressed, despite volume changes and/or displacements of the anode active material layer 22 during charging and discharging processes.

Referring to FIG. 5, an all-solid secondary battery 40a may further include, for example, a metal layer 23 disposed between the anode current collector 21 and the anode active material layer 22. The metal layer 23 may be a metal foil or a plated metal layer. The metal layer 23 may include lithium or a lithium alloy. Accordingly, the metal layer 23 may act as a lithium reservoir, for example. The lithium alloy may be, for example, a Li—Al alloy, a Li—Sn alloy, a Li—In alloy, a Li—Ag alloy, a Li—Au alloy, a Li—Zn alloy, a Li—Ge alloy, or a Li—Si alloy. The metal layer 23 may have a thickness of, for example, about 1 μm to about 200 μm, about 1 μm to about 100 μm, about 1 μm to about 70 μm, about 1 μm to about 50 μm, about 1 μm to about 30 μm, or about 1 μm to about 20 μm. With the metal layer 23 having a thickness in the aforementioned ranges, the all-solid secondary battery 40 may have improved cycling performance.

In the all-solid secondary battery 40a, the metal layer 23 may be, for example, disposed between the anode current collector 21 and the anode active material layer 22 prior to assembly of the all-solid secondary battery 40a, or the metal layer 23 may be plated between the anode current collector 21 and the anode active material layer 22 after assembly of the all-solid secondary battery 40a. In a case in which the metal layer 23 is positioned between the anode current collector 21 and the anode active material layer 22 prior to assembly of the all-solid secondary battery 40a, the metal layer 23, due to being a metal layer containing lithium, may act as a lithium reservoir. In a case in which the metal layer 23 is to be plated by charging after assembly of the all-solid secondary battery 40a, because the metal layer 23 is absent at the time of assembly of the all-solid secondary battery 40a, the energy density of the all-solid secondary battery 40a may be increased. In addition, in a case in which the metal layer 23 is positioned by charging after assembly of the all-solid secondary battery 40a, the anode current collector 21, the anode active material layer 22, and the region therebetween may be, for example, a Li-free region that does not include lithium (Li) while the all-solid secondary battery 40a is in the initial state or in a state after discharging.

The anode current collector 21 may be formed of a material that does not react with lithium, for example, a material that does not form an alloy or a compound with lithium. Examples of the material forming the anode current collector 21 may include copper (Cu), stainless steel, titanium (Ti), iron (Fe), cobalt (Co), nickel (Ni), or the like. However, the material forming the anode current collector 21 is not necessarily limited to the aforementioned materials but may be any material available as an electrode current collector in the art. The anode current collector 21 may be formed of one type of the aforementioned metals, an alloy of two or more types metals thereof, or a covering material.

For example, the all-solid secondary battery may further include, on the anode current collector 21, a thin film including an element alloyable with lithium. The thin film may be positioned between the anode current collector 21 and the anode active material layer 22. The thin film may include an element alloyable with lithium, such as gold (Au), silver (Ag), zinc (Zn), tin (Sn), indium (In), silicon (Si), aluminum (Al), bismuth (Bi), or the like. The thin film may be composed of one of the aforementioned metals or may be composed of an alloy of various kinds of metals. With the thin film disposed on the anode current collector 21, the form of the metal layer 23 being plated between the thin film and the anode active material layer 22 may be further planarized, and the cycling performance of the all-solid secondary battery 40a may further improve.

For example, the thin film may have a thickness of about 1 nm to about 800 nm, about 10 nm to about 700 nm, about 50 nm to about 600 nm, or about 100 nm to about 500 nm. With the thin film having a thickness in the aforementioned ranges, an all-solid secondary battery having improved cycling performance may be prepared. The thin film may be disposed on the anode current collector 21 by, for example, methods such as a vacuum deposition method, a sputtering method, and a plating method.

### Multilayer Ceramic (MLC) Battery

A MLC battery may include, for example, a plurality of cathodes; a plurality of anodes alternately disposed between the plurality of cathodes; and solid electrolyte layers alternately disposed between the plurality of cathodes and the plurality of anodes. The solid electrolyte layer may contain a composite solid electrolyte according to an embodiment.

The MLC battery may be, for example, a sintered product of a laminate in which a cathode active material composition, an anode active material composition, and a solid electrolyte precursor are sequentially laminated. The MLC battery may be a laminate in which a cathode active material, an anode active material, and a solid electrolyte are sequentially laminated, or may be a sintered product of the laminate.

The cathode active material composition may include a cathode active material and a binder. The cathode active material composition may further include a conductive material. For the binder and the conductive material, a binder and a conductive material mentioned with respect to the cathode of an all-solid secondary battery may be used.

The cathode active material composition may include a composite solid electrolyte-forming precursor according to an embodiment. The composite solid electrolyte-forming precursor may be converted to a composite solid electrolyte during a co-sintering process of a laminate described below.

A MLC battery may be provided with, for example, a laminated structure in which a plurality of unit cells are laminated such that a cathode active material layer and an anode active material layer opposes each other, while each unit cell includes a cathode including a cathode active material layer; a solid electrolyte layer; and an anode including an anode active material layer wherein the cathode, the anode, and the solid electrolyte layer are sequentially continuously disposed. For example, the MLC battery may further include a cathode current collector and/or an anode current collector. If the MLC battery includes a cathode current collector, a cathode active material layer may be disposed on both sides of the cathode current collector. If the MLC battery includes an anode current collector, an anode active material layer may be disposed on both sides of the anode current collector. Inclusion of a cathode current collector and/or an anode current collector in an MLC battery may further improve high-rate capability of the battery. In the MLC battery, unit cells may be stacked together by providing a current collector layer on any one or both of the uppermost layer and the lowermost layer of the laminate, or by inserting a metal layer into the laminate. The MLC battery or thin-film battery may be a small or ultra-small battery that can be applied, for example, as a power source for applications of Internet of Things (IoT) or a power source for wearable devices. The MLC battery or thin film battery may also be applied to medium- to large-sized batteries in an electric vehicle (EV), an energy storage system (ESS), or the like.

The anode included in the MLC battery may include, for example, an anode active material of a lithium metal phosphate, a lithium metal oxide, a metal oxide, a carbon-containing anode active material, or a combination thereof.

The carbon-containing anode active material may include, for example, amorphous carbon, crystalline carbon, porous carbon, or a combination thereof. Examples of the crystalline carbon include graphite such as natural graphite or artificial graphite in shapeless, plate-shaped, flake-shaped, spherical, or fibrous form.

Examples of the amorphous carbon include carbon black (CB), acetylene black (AB), furnace black (FB), Ketjen black (KB), graphene, soft carbon or hard carbon, mesophase pitch carbide, calcined cokes, or the like. Amorphous carbon, which is carbon with no crystalline structure or with an extremely low degree of crystallinity, may be distinct from crystalline carbon.

The carbon-containing anode active material may be, for example, porous carbon. For example, pores included in the porous carbon may have a pore volume of about 0.1 cubic centimeters per gram (cc/g) to about 10.0 cc/g, about 0.5 cc/g to about 5 cc/g, or about 0.1 cc/g to about 1 cc/g. For example, pores included in the porous carbon may have an average pore diameter of about 1 nm to about 50 nm, about 1 nm to about 30 nm, or about 1 nm to about 10 nm. The Brunauer, Emmett and Teller (BET) specific surface of the porous carbon may be, for example, about 100 square meters per gram (m²/g) to about 3,000 m²/g.

The anode active material may be, for example, a compound selected from Li_{4/3}Ti_{5/3}O₄, LiTiO₂, LiM1ₛM2ₜOᵤ (M1 and M2 are each a transition metal, and s, t, and u are each any positive number), TiOₓ (0<x≤3), and LiₓV₂(PO₄)₃ (0<x≤5). The anode active material according to an embodiment may be Li_{4/3}Ti_{5/3}O₄, LiTiO₂, or a combination thereof.

The cathode included in the MLC battery may include a cathode active material. The cathode active material may be selected from cathode active materials used in an all-solid secondary battery. The cathode active material may include a lithium metal phosphate, a lithium metal oxide, or a combination thereof, and may include, for example, lithium cobalt oxide, lithium iron phosphate, lithium nickel cobalt manganese oxide, lithium nickel cobalt aluminum oxide, lithium nickel cobalt manganese aluminum oxide, or a combination thereof.

The current collector layer may function as a cathode current collector and/or an anode current collector. The current collector layer may be, for example, made of any metal selected from Ni, Cu, Ag, Pd, Au, and Pt. The current collector layer may be made of, for example, an alloy containing any one of Ni, Cu, Ag, Pd, Au, and Pt. The alloy may be, for example, an alloy of two or more selected from Ni, Cu, Ag, Pd, Au, and Pt. The alloy may be, for example, an Ag/Pd alloy. The metal and the alloy may each be a single type or a mixture of two or more types. The current collector layer as a cathode current collector and the current collector layer as an anode current collector may utilize the same material or a different material from each other. Since an alloy or mixed powder containing Ag and Pd, by adjusting its mixing ratio, can adjust its melting point to any melting point between the melting point of silver (962° C.) and the melting point of palladium (1,550° C.), the melting point may be adjusted to a batch-sintering temperature. In addition, the alloy or mixed powder containing Ag and Pd, due to having high electronic conductivity, may suppress an increase of battery internal resistance.

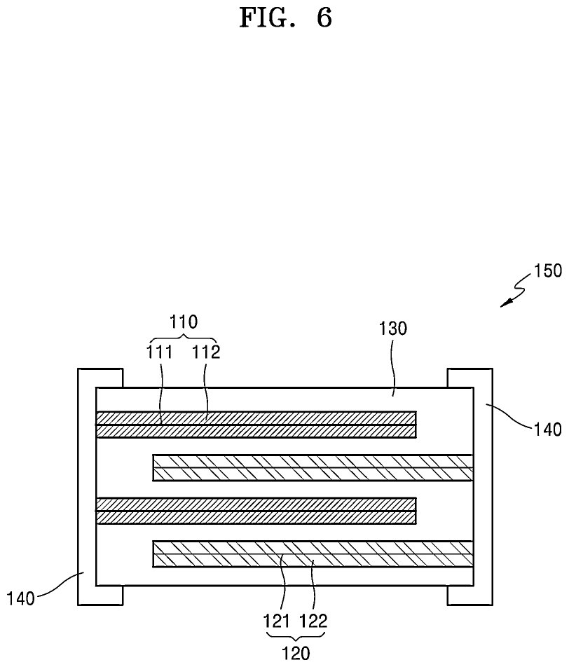

FIG. 6 is a schematic cross-sectional diagram of an embodiment of an MLC battery.

Referring to FIG. 6, a cathode active material layer 112 may be disposed on both sides of a cathode current collector 111 to form a cathode 110. An anode active material layer 122 may be laminated on both sides of an anode current collector 121 to form an anode 120. A composite solid electrolyte 130 according to an embodiment may be disposed between the cathode 110 and the anode 120. An external electrode 140 may be formed on both ends of a battery body 150. The external electrode 140 may be connected to the cathode 110 and the anode 120, each of which has a tip portion exposed outside the battery body 150, and may act as an external terminal electrically connecting the cathode 110 and the anode 120 to an external device. One of a pair of external electrodes 140 may have one end thereof connected to the cathode 110 exposed outside the battery body 150, and the other one of the pair of external electrodes 140 may have the other end thereof connected to the anode 120 exposed outside the battery body 150.

A MLC battery 150 may be prepared through a process in which a cathode, a solid electrolyte, and an anode are sequentially laminated to prepare a laminate, and a plurality of the laminate are stacked together and heat-treated simultaneously.

Details of a method of preparing the MLC battery according to an embodiment are as follows.

First, a composite solid electrolyte forming-composition may be obtained by mixing a first solid electrolyte precursor having a cubic garnet phase and a pyrochlore phase with a second solid electrolyte having a glass phase, and the composite solid electrolyte forming-composition may be coated and dried on a substrate, to thereby form a composite solid electrolyte precursor film. The composite solid electrolyte precursor film may contain i) a first solid electrolyte precursor having an amorphous phase, and ii) a second solid electrolyte precursor having a glass phase.

If the composite solid electrolyte precursor film has a free-standing state, the substrate may be omitted.

A cathode may be formed by printing a cathode-forming composition on the substrate and disposing the composite solid electrolyte precursor film on the substrate.

The cathode-forming composition may include a cathode active material and a binder. In particular, for the cathode active material and the binder, the same cathode active material and binder used in an all-solid secondary battery may be used. In addition, the cathode-forming composition may include a composite solid electrolyte forming-composition according to an embodiment. The composite solid electrolyte forming-composition may include i) a first solid electrolyte precursor having an amorphous phase, and ii) a second solid electrolyte precursor having a glass phase.

Subsequently, a cathode current collector and a cathode may be formed on a side of the cathode that is not in contact with the composite solid electrolyte precursor film, to thereby form a substrate/solid electrolyte precursor film/cathode/cathode current collector/cathode laminate. The cathode current collector may be formed, for example, by printing a cathode current collector composition.

Separately, an anode may be formed by printing an anode-forming composition on a substrate and disposing a composite solid electrolyte precursor film on the substrate.

The anode-forming composition may include an anode active material and a binder. In particular, the binder may be the same binder as the binder used in the all-solid secondary battery.

The cathode-forming composition and the anode-forming composition may include a solvent.

Subsequently, an anode current collector and an anode may be formed on a side of the cathode that is not in contact with the composite solid electrolyte precursor film, to thereby form a substrate/solid electrolyte precursor film/anode/anode current collector/anode laminate. The anode current collector may be formed, for example, by printing an anode current collector composition.

The substrate may be separated and removed from the substrate/solid electrolyte precursor film/cathode/cathode current collector/cathode laminate to prepare a solid electrolyte precursor film structure A without the substrate. Separately from this, the substrate may be separated and removed from the substrate/composite solid electrolyte precursor film/anode/anode current collector/cathode laminate to prepare a composite solid electrolyte precursor film structure B without the substrate. The solid electrolyte precursor film structure A and the solid electrolyte precursor film structure B may be laminated and then compressed to form a battery structure.

The cathode current collector composition and the anode current collector composition may each include a metal selected from copper, aluminum, nickel, silver, gold, and an alloy thereof, and a conductive oxide, or a combination thereof. As a specific example, aluminum may be used as a cathode current collector and copper may be used as an anode current collector.

Then, cutting of the pressed battery structure may be performed. In particular, the cutting size of the battery structure may vary depending on the capacity of the MLC battery, and the cutting may be performed, for example, for a size having a width of about 5 mm to about 15 mm, for example, 10 mm, and a length of about 5 mm to about 15 mm, for example, 10 mm. This cutting process may be omitted.

The structure obtained through the aforementioned process may be co-sintered to produce a unit cell in which cathode/current collector/cathode/composite solid electrolyte/anode/current collector/anode are laminated.

The co-sintering may be performed at 550° C. or less, for example. During this co-sintering process, the composite solid electrolyte film including a first solid electrolyte precursor having an amorphous phase, and a second solid electrolyte precursor having a glass phase may be converted to a composite solid electrolyte including a first solid electrolyte having a cubic garnet phase and pyrochlore phase, and a second solid electrolyte having lithium haloboracite including a crystalline phase.

By laminating a plurality of the unit cells obtained through the aforementioned process and forming an external electrode, an MLC battery according to an embodiment may be manufactured.

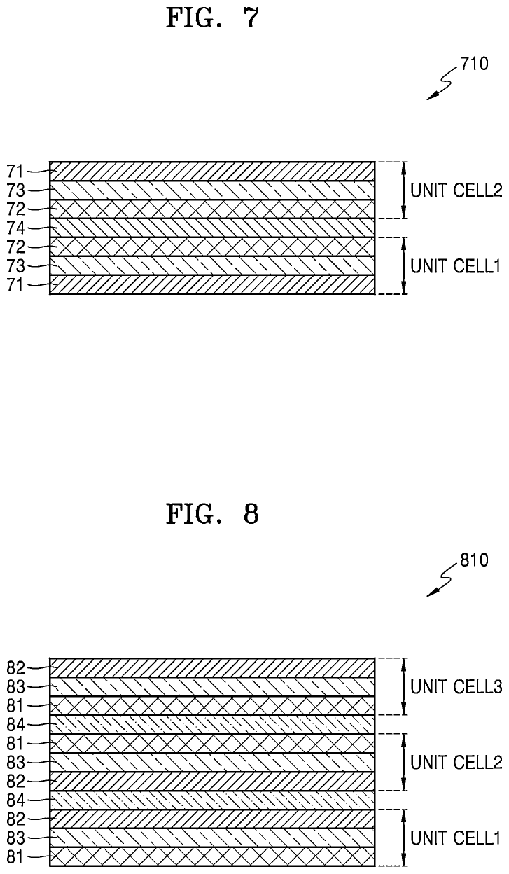

FIGS. 7 and 8 are schematic cross-sectional diagrams of embodiments of a structure of a MLC battery.

As shown in FIG. 7, in the MLC battery 710, a unit cell 1 and a unit cell 2 may be laminated on opposing sides of an internal current collector layer 74. The unit cell 1 and the unit cell 2 may each be composed of a cathode 71, a solid electrolyte layer 73, and an anode 72 that are sequentially laminated. The unit cell 1, the unit cell 2, and the inner current collector layer 74 may be laminated such that the anode 72 of the unit cell 2 is adjacent to one side of an inner current collector layer 74 (top side in FIG. 9) and the anode 72 of the unit cell 1 is adjacent to the opposing side of the inner current collector layer 74 (bottom side in FIG. 12). The inner current collector layer 74, although illustrated in FIG. 7 as being positioned in contact with the anode 72 of each of the unit cell 1 and the unit cell 2, may also be positioned in contact with the cathode 71 of each of the unit cell 1 and the unit cell 2. The inner current collector layer 74 may include an electronically conductive material. The inner current collector layer 74 may further include an ionically conductive material. Further including an ionically conductive material may improve voltage stability characteristics. Because both sides of the inner current collector layer 74 has the same polarity in an MLC battery 710, a monopolar-type MLC battery 710, which has a plurality of unit cells connected in parallel to each other by the inner current collector layer 74 inserted therein, may be obtained. As a result, a high-capacity MLC battery 710 may be obtained. Because the inner current collector layer 74 inserted between the unit cell 1 and the unit cell 2 includes an electronically conductive material in the MLC battery 710, a parallel electrical connection between two adjacent unit cells may be possible, and at the same time, an ionically conductive connection between the cathode 71 or anode 72 in two adjacent unit cells may become possible. Because electric potentials of adjacent anodes 71 or cathodes 72 can be averaged through the inner current collector layer 74, a stable output voltage may be obtained. In addition, an external current collecting member, such as a tab, may be omitted, and a parallel electrical connection between unit cells constituting the MLC battery 710 may become possible. As a result, the MLC battery 710 having excellent space efficiency and cost-effectiveness may be obtained. Referring to FIG. 8, the laminate may include a cathode 81, an anode 82, a solid electrolyte layer 83, and an inner current collector layer 84. The laminate may be laminated and thermally compressed to form an MLC battery stack 810. The cathode 81 may be composed of a single cathode sheet, and the anode 82 may be composed of two anode sheets.

Hereinbelow, the present disclosure will be described in greater detail in conjunction with Examples and Comparative Examples, but is not limited to the examples disclosed below.

### Preparation of First Solid Electrolyte Precursor and Second Solid Electrolyte Precursor

### Preparation Example 1: Synthesis of Li_{6.5}La₃Zr_{1.5}Ta_{0.5}O₁₂ Having Amorphous Phase

Li₂O, La₂O₃, ZrO₂, and Ta₂O₅ were mixed in a stoichiometric manner, and the resulting mixture was introduced into a high-energy ball mill and dry-milled in an inert atmosphere for 15 hours to prepare amorphous Li_{6.5}La₃Zr_{1.5}Ta_{0.5}O₁₂. During the high-energy ball milling process, the temperature inside the ball-mill reactor was 100° C. or greater. This product was obtained in a powder form with an average particle diameter (D50) of about 100 nm.

### Preparation Example 2: Preparation of Li₄B₄Al₃O₁₂Cl Having Glass Phase

Li₂CO₃, B₂O₃, γ-Al₂O₃, and LiCl were stoichiometrically mixed, and this mixture was heat-treated at 1,100° C. in an electric furnace to provide a liquid-phase product. This liquid-phase product was quenched to obtain Li₄B₄Al₃O₁₂Cl having a glass phase.

### Preparation of Composite Solid Electrolyte

### Example 1

Li_{6.5}La_{2.4}Zr_{1.2}Ta_{0.4}O₁₂, which is a first solid electrolyte precursor having an amorphous phase, obtained according to Preparation Example 1, and glass powder Li₄B₄Al₃O₁₂Cl having a glass phase obtained according to Preparation Example 2, were mixed, and the resulting mixture was subjected to hot press sintering (HPS) in an atmospheric air at 480° C. for 2 hours with 250 megapascals (MPa) to prepare a composite solid electrolyte sintered body having a thickness of about 500 μm. The mixing volume ratio of the first solid electrolyte precursor having an amorphous phase to the glass powder was 97.2:2.8.

The composite solid electrolyte obtained through the aforementioned process includes a composite crystalline phase, and the composite crystalline phase contains a crystalline (cubic garnet) phase of the first solid electrolyte, and a crystalline phase of lithium chloroboracite, which is the second solid electrolyte.

### Example 2

A composite solid electrolyte was prepared following the same process as Example 1, except that the mixing volume ratio of the first solid electrolyte precursor having an amorphous phase obtained according to Preparation Example 1 to the glass powder obtained according to Preparation Example 2 was changed to 94.5:5.5.

### Example 3

A composite solid electrolyte was prepared following the same process as Example 1, except that the mixing volume ratio of the first solid electrolyte precursor having an amorphous phase obtained according to Preparation Example 1 to the glass powder obtained according to Preparation Example 2 was changed to 89.6:10.4.

### Example 4

A composite solid electrolyte was prepared following the same process as Example 1, except that the mixing volume ratio of the first solid electrolyte precursor having an amorphous phase obtained according to Preparation Example 1 to the glass powder obtained according to Preparation Example 2 was changed to 65:35.

### Example 5

A composite solid electrolyte was prepared following the same process as Example 1, except that the mixing volume ratio of the first solid electrolyte precursor having an amorphous phase obtained according to Preparation Example 1 to the glass powder obtained according to Preparation Example 2 was changed to 80:20.

### Comparative Example 1

Commercially available Li_{6.5}La₃Zr_{1.5}Ta_{0.5}O₁₂ powder (Toshima, LLZ powder, hereinafter referred to as C-LLZTO) having a garnet-type crystal structure (cubic phase) was subjected to HPS in an atmospheric air at 480° C. for 2 hours with 250 MPa to prepare a sintered body having a thickness of about 500 μm. This sintered product was used as a solid electrolyte.

### Comparative Example 2

A composite solid electrolyte was prepared following the same process as Example 1, except that the C-LLZTO of Comparative Example 1 was used instead of the first solid electrolyte precursor having an amorphous phase obtained according to Preparation Example 1, and the mixing volume ratio of C-LLZTO of Comparative Example 1 to glass powder was changed to 94.5:5.5. For the glass powder, the same glass powder used in Example 1 was used.

### Comparative Example 3

A composite solid electrolyte was prepared following the same process as Comparative Example 2, except that the mixing volume ratio of C-LLZTO of Comparative Example 1 to glass powder was changed to 89.6:10.4.

### Comparative Example 4

A composite solid electrolyte was prepared following the same process as Example 2, except that the mixing volume ratio of the amorphous first solid electrolyte precursor to the glass powder obtained according to Preparation Example 1 was changed to 50:50.

### Evaluation Example 1: X-Ray Diffraction Analysis

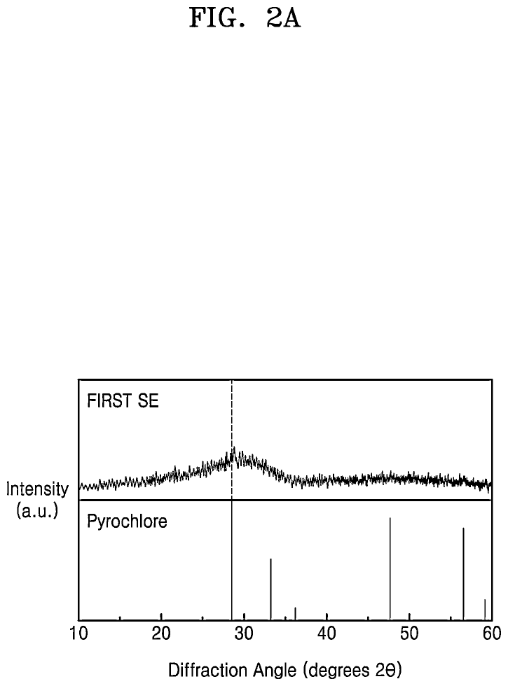

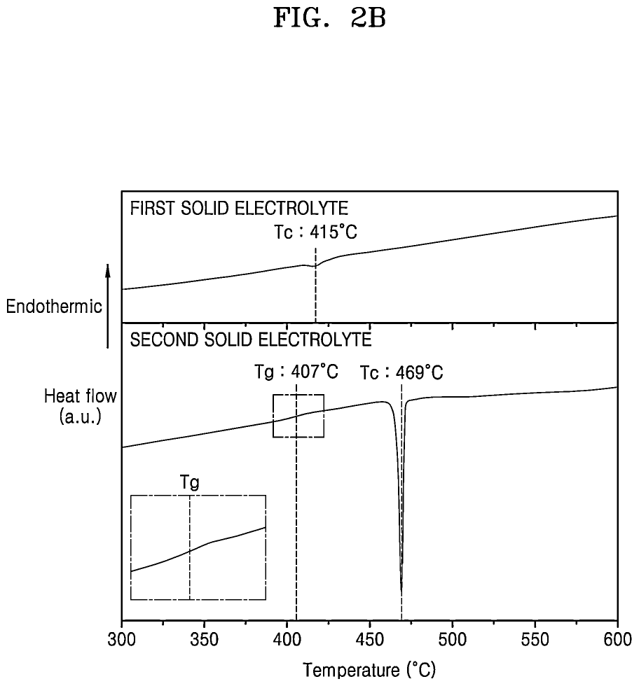

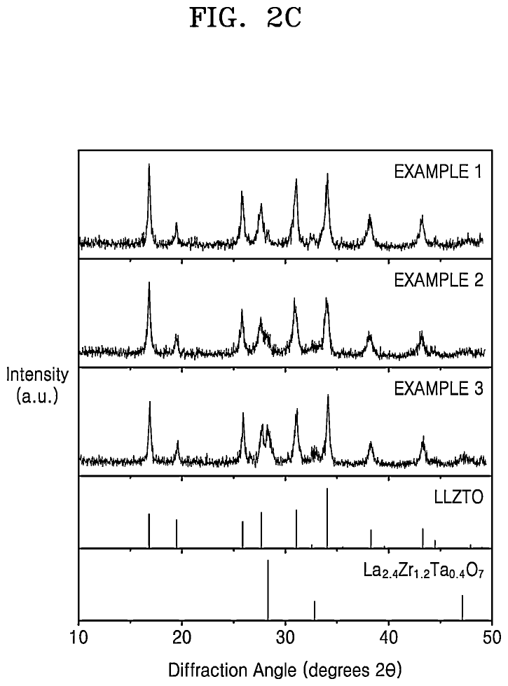

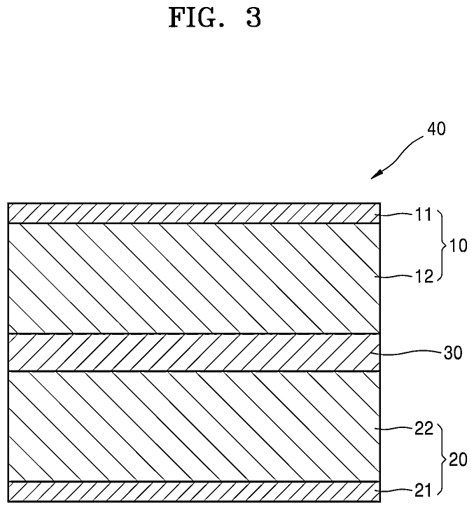

An XRD spectrum of the first solid electrolyte precursor (top image, labeled “FIRST SE”) having an amorphous phase prepared in Preparation Example 1 is shown in FIG. 2A. An XRD spectrum of LZT (La_{2.4}Zr_{1.2}Ta_{0.4}O₇) with a pyrochlore phase is shown in FIG. 2A (bottom image, labeled “Pyrochlore”). The XRD spectra were obtained using an X'pert pro (PANalytical) using Cu Kα radiation (1.54056 angstroms, A).

Referring to FIG. 2A, the first solid electrolyte precursor obtained according to Preparation Example 1 was found to have a substantially amorphous phase.

### Evaluation Example 2: Differential Scanning Calorimetry (DSC) Analysis

The first solid electrolyte precursor having an amorphous phase and the glass second solid electrolyte precursor used in the preparation of the composite solid electrolyte of Example 1 were analyzed by DSC, and the spectra are shown in FIG. 2B.

Referring to FIG. 2B, it was found that the first solid electrolyte precursor (top image) has an exothermic peak at a lower temperature than the second solid electrolyte precursor (bottom image), which indicates that the first solid electrolyte has a crystallization temperature less than a crystallization temperature of the second solid electrolyte. In addition, it was found that the glass transition temperature of the second solid electrolyte was in a region near the crystallization temperature Tc of the first solid electrolyte, as shown in FIG. 2B. The second solid electrolyte having fluidity was able to fill the pores generated as the first solid electrolyte crystallized.

### Evaluation Example 3: X-Ray Diffraction Analysis

XRD spectra of the composite electrolyte sintered bodies prepared in Examples 1 to 3 are shown in FIG. 2C. In FIG. 2C, the LLZTO labeled spectrum is for LLZTO (Li_{6.5}La_{2.4}Zr_{1.2}Ta_{0.4}O₁₂) having a cubic garnet phase, and the LZT labeled spectrum is for LZT (La_{2.4}Zr_{1.2}Ta_{0.4}O₇) having a pyrochlore phase.

The XRD spectra were obtained using X'pert pro (PANalytical) using Cu Kα radiation (1.54056 Å).

As shown in FIG. 2C, the composite solid electrolyte of Example 1 includes a cubic garnet crystal phase as a main phase and includes a small amount of a pyrochlore phase, and peaks associated with the pyrochlore phase appeared at a diffraction angles of 28.35°2θ (crystal plane 111), 32.85°2θ, and 47.14°2θ (crystal plane 220).

### Evaluation Example 4: Ionic Conductivity Measurement

A gold (Au) electrode was deposited by sputtering on both sides of a pellet for each of the composite solid electrolytes of Examples 1 to 3, the solid electrolyte of Comparative Example 1, and the composite solid electrolytes prepared in Comparative Examples 2 to 4. Impedance of a sample with shield electrodes formed on both sides thereof was measured by the 2-probe method using an impedance analyzer (Solartron 1400A/1455A impedance analyzer). The frequency range was 1 hertz (Hz) to 1 megahertz (MHz), and the amplitude voltage was 10 millivolts (mV). Measurements were taken in a dry air atmosphere at 25° C. Resistance values were obtained from the arc of the Nyquist plot of the obtained impedance measurements, and by correcting electrode area and pellet thickness therefrom, ionic conductivity was calculated, and a results thereof are shown in Table 1.

From each impedance result, a total resistance (Rₜₒₜₐₗ) value was obtained, and from this value, electrode area and pellet thickness were corrected to calculate a conductivity value.

The solid electrolyte of Comparative Example 1, including LLZTO having a garnet-type crystal structure (cubic phase), was found to have low ionic conductivity (4.12×10⁻⁷ S/cm).

In the composite solid electrolytes of Comparative Examples 2 and 3, it was found that the amount of the second solid electrolyte was 5.5% and 10.4%, respectively, and the relative density was 60.4% and 67.4%, respectively.

The composite solid electrolytes of Examples 1 to 3 exhibited a significantly high conductivity and relative density compared to Comparative Examples 1 to 3.

In addition, it was found that the ionic conductivity of the composite solid electrolyte increased as the amount of the second solid electrolyte decreased, and the relative density of the composite solid electrolyte increased as the amount of the second solid electrolyte increased.

### Evaluation Example 5: SEM Analysis

SEM analysis was performed on a cross-section of each of the composite solid electrolytes prepared in Examples 1 to 3 by using SU-8030 (Hitachi). The composite solid electrolytes of Examples 1 to 3 were found to have a structure densified at low temperature, in which the second solid electrolyte was dispersed within the matrix of the high-conductivity first solid electrolyte.

### Evaluation Example 6: Relative Density

Relative densities of the composite solid electrolytes of Examples 1 to 3, the solid electrolyte of Comparative Example 1, and the composite solid electrolytes prepared according to Comparative Examples 2 to 4 were investigated and results are shown in Table 1. Relative density of the pellet was obtained through the ratio of measured density to theoretical density. In particular, the measured density was obtained by using a densimeter based on Archimedes' principle, or from an apparent volume and weight of a sintered pellet. The theoretical density of a pellet was determined by a measurement method based on apparent density and was expressed as a density value obtained by taking the theoretical densities of Ta-doped LLZTO and Li₄B₄Al₃O₁₂Cl, 5.3 g/cm³ and 2.3 g/cm³, respectively, as 100% with the mixing ratio of the first solid electrolyte and the second solid electrolyte taken into consideration.

TABLE 1

| | Ionic | Relative |
|---|---|---|
| Item | conductivity [S/cm] | density (%) |
| Example 1 | 4.41 × 10⁻⁵ | 91.5 |
| Example 2 | 4.20 × 10⁻⁵ | 94.0 |
| Example 3 | 1.19 × 10⁻⁵ | 99.1 |
| Comparative | 4.12 × 10⁻⁷ | 60.4 |
| Example 1 | | |
| Comparative | 3.02 × 10⁻⁶ | 67.4 |
| Example 2 | | |
| Comparative | 2.47 × 10⁻⁷ | 70.9 |
| Example 3 | | |

Referring to Table 1, it was found that the composite solid electrolytes of Examples 1 to 3 have significantly increased relative density compared to Comparative Examples 1 to 3.

According to an aspect of the disclosure, a composite solid electrolyte according to an embodiment may be used to prepare a composite solid electrolyte having superior conductivity and density at low temperatures. By using this composite solid electrolyte, it may be possible to provide a lithium battery which can be sintered at low temperature and has improved energy density and cycling performance.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A composite solid electrolyte comprising:
a first solid electrolyte and a second solid electrolyte, the first solid electrolyte comprising a cubic garnet phase and a pyrochlore phase, and the second solid electrolyte comprising lithium haloboracite,
wherein a volume of the first solid electrolyte is greater than a volume of the second solid electrolyte based on a total volume of the composite solid electrolyte, and
wherein the lithium haloboracite comprises chlorine, bromine, iodine, or a combination thereof.

2. The composite solid electrolyte of claim 1,
wherein the lithium haloboracite comprises a crystalline phase.

3. The composite solid electrolyte of claim 1,
wherein a crystallization temperature T1 of the first solid electrolyte is less than a crystallization temperature T2 of the second solid electrolyte.

4. The composite solid electrolyte of claim 1,
wherein a crystallization temperature of the first solid electrolyte is about 300° C. to about 450° C., and
a crystallization temperature of the second solid electrolyte is about 450° C. to about 550° C.

5. The composite solid electrolyte of claim 1,
wherein the composite solid electrolyte includes a heat-treated product of a composite solid electrolyte-forming composition comprising a first solid electrolyte precursor and a second solid electrolyte precursor, wherein a heat treatment temperature T of the composite solid electrolyte-forming composition is 600° C. or less, and
wherein a crystallization temperature T1 of the first solid electrolyte, the heat treatment temperature T of the composite solid electrolyte-forming composition, and a crystallization temperature T2 of the second solid electrolyte satisfy Relation 1:
T1<T2<T. Relation 1

6. The composite solid electrolyte of claim 1,
wherein an average crystallite size of a crystalline phase of the first solid electrolyte is about 50 nanometers to about 50 micrometers.

7. The composite solid electrolyte of claim 1,
wherein the composite solid electrolyte has an ionic conductivity of about 1×10⁻⁶ siemens per centimeter to about 1×10⁻³ siemens per centimeter.

8. The composite solid electrolyte of claim 1,
wherein the composite solid electrolyte has a relative density of about 80% to about 99.5% based on a theoretical density of the composite solid electrolyte.

9. The composite solid electrolyte of claim 1,
wherein an amount of the first solid electrolyte in the composite solid electrolyte is greater than 50 volume percent and 99 volume percent or less based on a total volume of the composite solid electrolyte.

10. The composite solid electrolyte of claim 1,
wherein the composite solid electrolyte has a porosity of about 0.5% to about 20%.

11. The composite solid electrolyte of claim 1,
wherein the first solid electrolyte comprises a compound represented by Formula 1:
(LiₓAₐ)(La_{y}B′_{b})(Zr_{z}C′_{c})O₁₂ Formula 1
wherein in Formula 1, A is a monovalent cation, a divalent cation, a trivalent cation, or a combination thereof,
B′ is a monovalent cation, a divalent cation, a trivalent cation, or a combination thereof,
C′ is a monovalent cation, a divalent cation, a trivalent cation, a tetravalent cation, a pentavalent cation, a hexavalent cation, or a combination thereof, and
5≤x≤7, 0≤a≤2, 2≤y≤3, 0≤b≤1, 0<z≤2, and 0≤c≤2.

12. The composite solid electrolyte of claim 11,
wherein the solid electrolyte represented by Formula 1 comprises a compound represented by Formula 2, a compound represented by Formula 3, or a combination thereof,
Liₓ(La_{y}B′_{b})(Zr_{z}C′_{c})O₁₂ Formula 2
wherein in Formula 2, B′ is calcium, strontium, cesium, barium, or a combination thereof,
C′ is aluminum, tungsten, niobium, tantalum, or a combination thereof,
5≤x≤7, 2≤y≤3, 0<z≤2, 0<b≤1, and 0.01≤c≤2,
(LiₓAₐ)(La_{y})(Zr_{z})O₁₂ Formula 3
wherein in Formula 3, A is gallium, aluminum, or a combination thereof, and 5≤x≤7, 0≤a≤2, 2≤y≤3, and 0<z≤2.

13. The composite solid electrolyte of claim 11,
wherein the solid electrolyte represented by Formula 1 is a compound represented by Formula 4:
Liₓ(La_{y}B′_{b})(Zr_{z}C′_{c})O₁₂ Formula 4
wherein in Formula 4, B′ is calcium, strontium, cesium, barium, or a combination thereof,
C′ is aluminum, tungsten, niobium, tantalum, or a combination thereof, and 5≤x≤7, 2≤y≤3, 0≤b≤1, 0<z≤2, and 0.01≤c≤2.

14. The composite solid electrolyte of claim 1,
wherein the second solid electrolyte is a compound represented by Formula 5:
Liₐ(BₓM_{y}N_{z})O_{b}X_{c} Formula 5
wherein in Formula 5, 4≤a≤7, 12≤b≤13, 0<c≤1, 0<x≤7, 0<y≤3, 0≤z≤1, and 6≤x+y+z≤7,
M and N are each independently Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, W, or a combination thereof, and
X is Cl, Br, I, or a combination thereof.

15. A lithium battery comprising:
a cathode;
an anode; and
an electrolyte layer disposed between the cathode and the anode,
wherein the cathode, the anode, the electrolyte layer, or a combination thereof comprise the composite solid electrolyte according to claim 1.

16. A method of preparing a composite solid electrolyte, the method comprising:
mixing a first solid electrolyte precursor having an amorphous phase with a second solid electrolyte precursor having a glass phase to prepare a composite solid electrolyte-forming composition; and
heat-treating the composite solid electrolyte-forming composition to prepare the composite solid electrolyte of claim 1.

17. The method of claim 16,
wherein the first solid electrolyte comprises a compound represented by Formula 1:
(LiₓAₐ)(La_{y}B′_{b})(Zr_{z}C′_{c})O₁₂ Formula 1
wherein in Formula 1, A is a monovalent cation, a divalent cation, a trivalent cation, or a combination thereof,
B′ is a monovalent cation, a divalent cation, a trivalent cation, or a combination thereof,
C′ is a monovalent cation, a divalent cation, a trivalent cation, a tetravalent cation, a pentavalent cation, a hexavalent cation, or a combination thereof, and
5≤x≤7, 0≤a≤2, 2≤y≤3, 0≤b≤1, 0≤z≤2, and 0≤c≤2.

18. The method of claim 16,
wherein the second solid electrolyte is a compound represented by Formula 5:
Liₐ(BₓM_{y}N_{z})O_{b}X_{c} Formula 5
wherein in Formula 5, 4≤a≤7, 12≤b≤13, 0<c≤1, 0<x≤7, 0≤y≤3, 0≤z≤1, and 6≤x+y+z≤7, M and N are each independently Al, Si, Ge, P, Fe, La, Y, Mo, Be, Cr, Sc, Ti, V, Mn, Co, Ni, Cu, Zn, Ga, Zr, Nb, Tc, Ru, Rh, Pd, Ag, Cd, In, Sn, Hf, Ta, W, or a combination thereof, and
X is Cl, Br, I, or a combination thereof.

19. The method of claim 16,
wherein the heat-treating of the composite solid electrolyte-forming composition is performed at a temperature greater than a crystallization temperature of the first solid electrolyte precursor and a crystallization temperature of the second solid electrolyte precursor.

20. The method of claim 16,
wherein the heat-treating of the composite solid electrolyte-forming composition is performed at 600° C. or less.
